(19) United States
(12) Patent Application Publication
(10) Pub. No.: US 2009/0216661 A1
(43) Pub. Date: Aug. 27, 2009

(54) SYSTEMS AND METHODS FOR ONLINE GARDEN DESIGN

(76) Inventor: Scott J. Warner, Las Vegas, NV (US)

Correspondence Address: CHOATE, HALL & STEWART LLP, TWO INTERNATIONAL PLACE, BOSTON, MA, 02110, US

(21) Appl. No.: 12/257,633

(22) Filed: Oct. 24, 2008

Related U.S. Application Data
(60) Provisional application No. 61/031,099, filed on Feb. 25, 2008.

(51) Int. Cl. G06Q 30/00

(52) U.S. Cl. 705/27; 47/58.1 R

(57) ABSTRACT

A method and system for improving the way fruit, vegetable and flower gardens are planned, designed, and implemented. The present application discloses systems and methods to simplify gardening, as well as improve the overall yield while mitigating such problems as over-planting, over/under irrigating, and poor maintenance. Systems and methods are described for an application utilizing a database to provide an interactive garden design, planning and implementation process.

### RELATED APPLICATION

This application claims priority to U.S. Provisional Patent Application Ser. No. 61/031099, filed on Feb. 25, 2008, entitled “Systems And Methods For Online Garden Design”, which is incorporated herein in its entirety by reference.

### FIELD OF THE DISCLOSURE

The present disclosure relates to garden design generally and specifically using an online system for designing, installing, maintaining and harvesting a garden, such as a fruit and/or vegetable garden or a flower bed.

### BACKGROUND OF THE DISCLOSURE

Planning and implementing a garden, such as a vegetable garden, involves many challenges and is more difficult than one might think. One challenge to designing a garden is finding information on the multitude of potential crops, plants or flowers to plant in a garden based on geography and soil composition. Another challenge to designing a garden is determining yield or monetary value estimates for each type of crop planted in a garden of a certain size. These challenges are compounded during the design of the garden as a garden owner selects multiple crops to plant and changes selections. Choosing between the multitude of potential crops is difficult without comprehensive details to support making more optimal decisions of yield, value or any other desired criteria. For example, determining crop selection to provide maximum yield, nutritional value or monetary value for a certain size garden is challenging based on the lack of information and multitude of potential crops from which to plant.

Upon selection of crops for planting in the garden, the challenges continue with respect to implementing the garden. The multitude of design choices also leads to a multitude of different types of installations and maintenance of the garden based on the design. Each design may result in a custom installation without specific instructions. Depending on the crop selection, the garden owner has to determine when each of the multiple crops should be planted in accordance with the type of crop. Still another challenge is finding, choosing and purchasing the seeds and other materials for installing the garden as specified by the design. Some other challenges include determining in some cases a design of an irrigation system suitable for maintaining the crops based on the garden design. Further to the maintenance of the garden, another challenge of the garden owner is to know when to weed or harvest the garden depending on the selected crops of the design.

### BRIEF SUMMARY OF THE DISCLOSURE

The present solution addresses the challenges and shortcomings of current methods for designing and planning a garden. The technology based information system of the present solution provides an interactive system for designing and implementing a garden. The present solution provides the following features and advantages:
Geographically-based information about potential crops and plants
Soil-composition-based information about the potential crops and plants.
Comprehensive details for each crop and plant for making optimal planting decisions.
Interactive way and user interface to design a garden.
A set of customized instructions for the implementation of the garden design.
An optimized irrigation design.
Notification system for providing notice of garden events such as when to plant, weed, or harvest.
Calculated yield estimates for each crop planted.
Calculated nutritional value estimates for each crop planted.
Calculated monetary value estimates for each crop planted.
A customized planting kit containing all the seeds, starters, and other materials for installation of the designed garden.
Tools and information to design and implement a garden providing maximum yield.
Integration with and provisioning of a la carte services to help the garden owner implement, care for and/or maintain the garden.

The present solution optimizes the entire life cycle of crops and plants. The garden design and implementation system includes components designed and constructed to address each stage of the entire life cycle process, thus, providing an optimized end-to-end solution for designing and implementing gardens.

In accordance with some embodiments, the present disclosure is directed to an improved system and method for designing and implementing a fruit, vegetable and/or flower garden. In one embodiment, a server system is connected to a network such as the Internet. The server is in communication with or connected to a database and an application is provided. The database includes information pertaining to each crop and plant such that various calculations may be performed to determine optimized locations for planting, requirements for sunlight, irrigation, and care to yield the maximum amount of produce. The database also has information pertaining to the value of the produce, the benefits of the produce in dietary terms such as nutritional value, and further information about the use, consumption and storage of the crop.

In another embodiment, the system provides the user with a web application to discover fruits, vegetables and flowers to plant based on any desired parameters of the user. The user interface of the application presents this data in various ways to allow simple and fast discovery of the data through groups such as “High Nutritional Value”, “Easy Maintenance”, “Long Storage”, “High Yield”, “High Monetary Value”, “Easy to Cook”, “Easy to Get Kids to Eat”. The application may guide the user through a selection process, such as via a wizard, to making the design choices for their garden, such as by providing optimization recommendations or selections to meet user or predetermined criteria.

In at least one embodiment, the system provides a tool, such as a Web or software application, to interactively discover an optimized layout for the implementation of garden. This tool may automatically place selected crops in an initial or default electronic representation of the available planting area for the garden. The user may modify the default layout in various ways including increasing or decreasing the amount of each crop to plant, selecting different ways to plan the layout by such factors as total yield and total value of yield. Responsive to the user's modifications, this tool may provide various information about each crop such as yield, monetary value, nutritional value, area requirements, costs, and other information that may be of interest to the user.

In some embodiments, the system provides a set of instructions for the set up of the garden, the planting, the care, and the harvesting based on any selected garden design. These instructions may be customized based on the user's soil conditions, available sunlight, chosen crops, growing zone, size of planting area, and other factors.

In another embodiment, the system provides an interface and method for selecting parts of the gardening implementation, maintenance or care for which to hire a service company. For example, if the user wishes to not prepare the ground for planting they may choose a local company to perform this activity as a service. The system may be automated such that once a service company has been chosen the relevant information is sent to the service provider automatically, for example, electronically. The system may send the service provider the garden design or any portion thereof, to enable the service provider to perform the service satisfactorily or otherwise in accordance with the design. In one embodiment, the system includes an interface for users to provide feedback about their experience with a service provider.

In some embodiments, the system provides an automated notification system to remind users of anything relevant to their garden, such as with respect to the care and maintenance of the garden. The system may notify users, for example through email, of events such as the date to plant a particular crop, or the date to weed or irrigate crops, or the date to begin harvesting a crop. These reminders may include any information and instructions needed to help the user perform any activities related to the event or notification.

In yet other embodiments, the system provides for the provisioning of a planting kit including all seeds and other materials needed to implement a garden. For example, the user may be able to order the planting kit, or portions thereof, via a user interface of an application of the system. The planting kit may be customized to and based on one or more garden designs chosen by the user. The planting kit may further be optimized to simplify the planting process and/or garden implementation.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1 is a block diagram of an embodiment of an environment and architecture for the interactive garden design and provisioning system;

FIG. 2 is a block diagram of an embodiment of an intelligent design engine for selecting and optimizing selection of one or more crops for a garden;

FIGS. 3A-3D are pictorial diagrams illustrating various embodiments of user interfaces of the system;

FIG. 4 is a flow diagram depicting an embodiment of steps of a method for using the system end-to-end for an entire lifecycle of the gardening process;

FIG. 5 is a block diagram depicting an embodiment of a kit for gardening based on a user specified garden design.

FIGS. 6A-6R are pictorial diagrams illustrating various embodiments of user interfaces of the system;

FIG. 7 is a flow diagram depicting an embodiment of steps of a method for selecting a garden design from a plurality of garden designs based on a theme;

FIG. 8 is a flow diagram depicting an embodiment of steps of a method for identifying one or more plants based on yield or market value information;

FIG. 9 is a flow diagram depicting an embodiment of steps of a method for providing a garden kit 500 comprising seeds and materials to implement an identified garden design;

FIG. 10 is a flow diagram depicting an embodiment of steps of a method for notifying a user of a service of one or more events related to maintenance of a garden according to a garden design identified by the user; and

FIG. 11 is a flow diagram depicting an embodiment of steps of a method for selecting one or more service providers to implement a specified garden design.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE DISCLOSURE

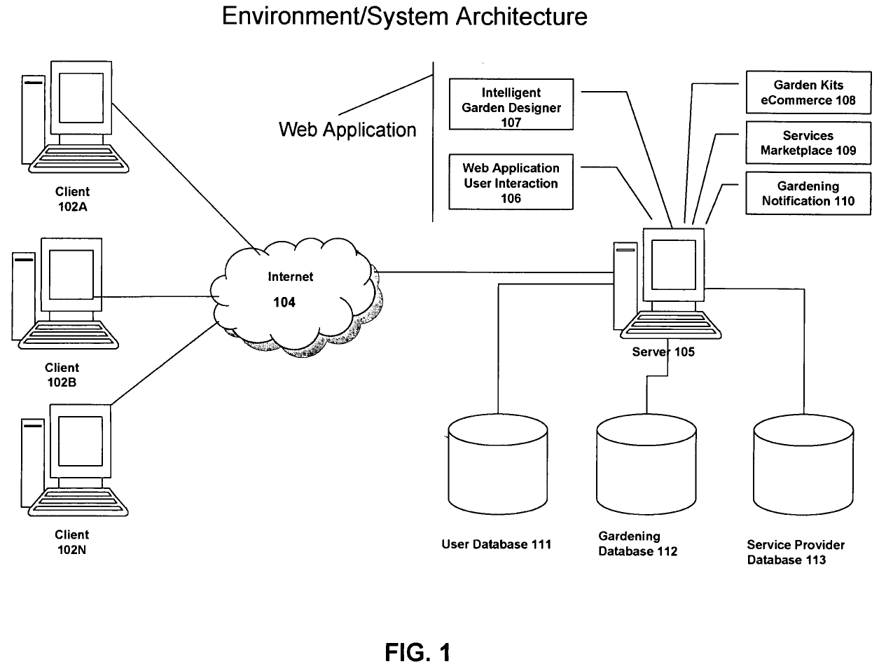

Referring to FIG. 1, a block diagram of an embodiment of an environment and system for providing a web-based application for interactively designing and planning a garden is depicted. In brief overview, the environment includes a web application server environment comprising of hardware and software components. The hardware components may include one or more computing devices or appliances, sufficient to and/or load-balanced to handle network traffic to the site and the execution of components of the web application for connected users. The software components may include one or more application modules for user interaction, database management, and intelligent garden design. The software components may also include one or more databases for storing data and information related to the application modules, and any use thereof, such as the garden designed by a user via use of the system.

In further overview, one or more clients 102A-102N (referred to as client(s) 102) are in communication with a server 105 via a network 104, such as the Internet. The server 105 comprises one or more of the following applications or modules to provide an interactive garden and design and planning system: intelligent garden designer 107, web application user interaction 106, garden kits ecommerce 108, services marketplace 109 and gardening notification 110. The server 105 and the applications thereof may be in communication with one or more the following databases: user database 111, gardening database 112 and the service provider database 113.

The server 105 comprises an embodiment of a hardware environment having one or more server computers to execute the web application, service user connections and/or manage the databases. In some embodiments, the server 105 may comprise more than a single computer, such as a server farm, server cluster or otherwise a group of multiple servers. Each server computer may execute some or all components or application modules of the system. In some cases, one or more server computers may execute some or all of the application modules for a limited number of users. In another embodiment, the components or application modules of the system may be separated to multiple server computers for execution. In some of these embodiments, each server system may comprise one or more server computers based on the total load of the system. The load may be a function of the number of concurrent user connections, the level of activity for connected to the system, the specific functions being performed by connected users, the average connection speed of connected users, the size and efficiency of the system's databases, as well as other factors, such as bandwidth, latency, response time, resource usage, type of network, type of user, etc.

Although FIG. 1 shows a network 104 between the clients 102A-N and the server 105, the clients 102 and the servers 105 may be on the same or different networks 104 and there may multiple networks between the client and the server. The networks 104 may be the same type of network or different types of networks. Any of the networks 104 of the client, server and between the client and server may be a local-area network (LAN), such as a company Intranet, a metropolitan area network (MAN), or a wide area network (WAN), such as the Internet or the World Wide Web. In one embodiment, the network 104 may be a private network. In another embodiment, the network 104 may be a public network. In some embodiments, the server may be on a private network and the client on a public network. In another embodiment, the client and the server may both be on private networks.

The network 104 be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein.

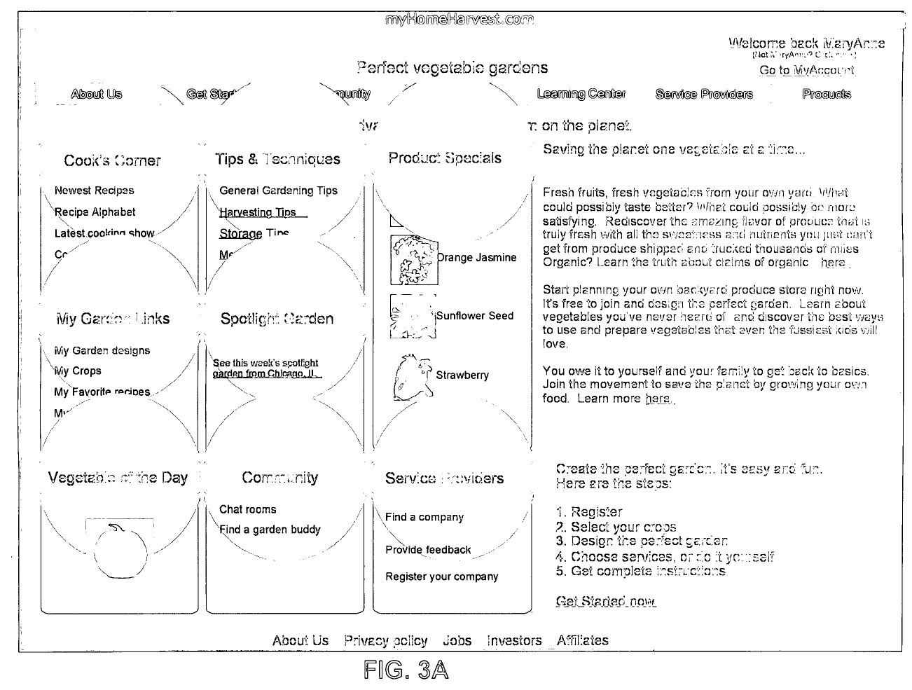

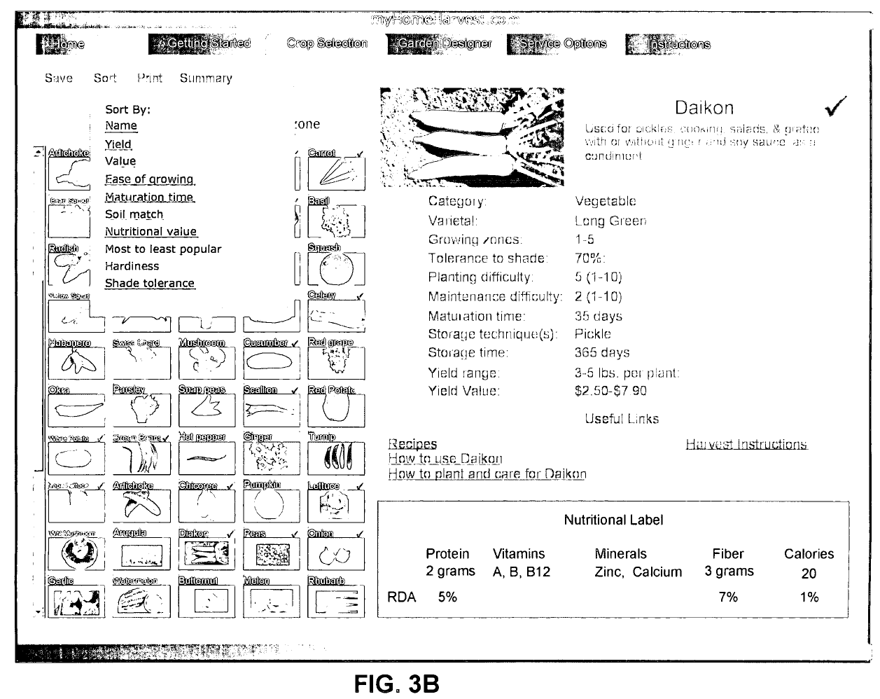

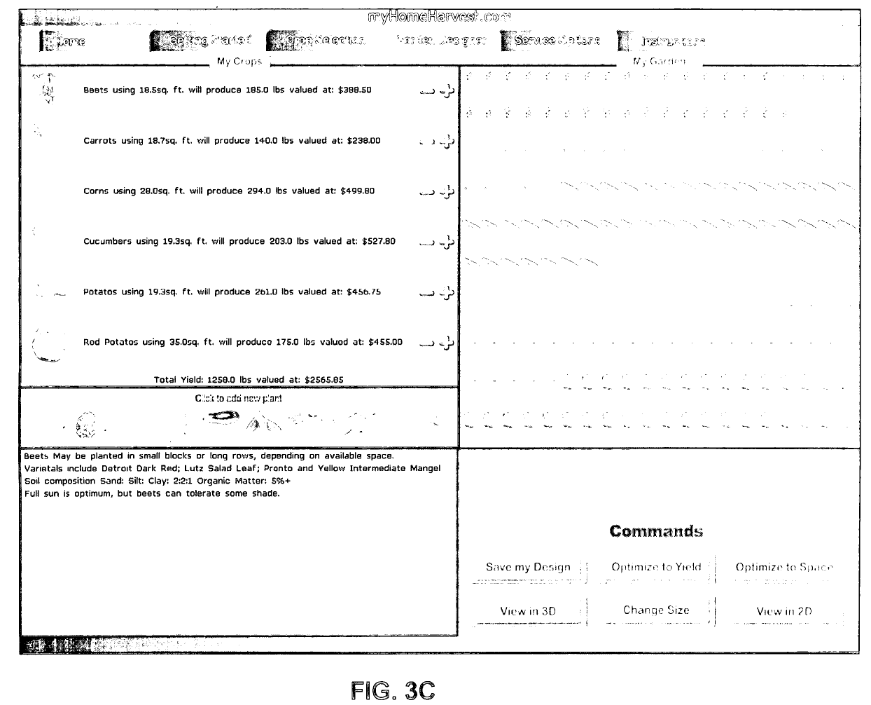

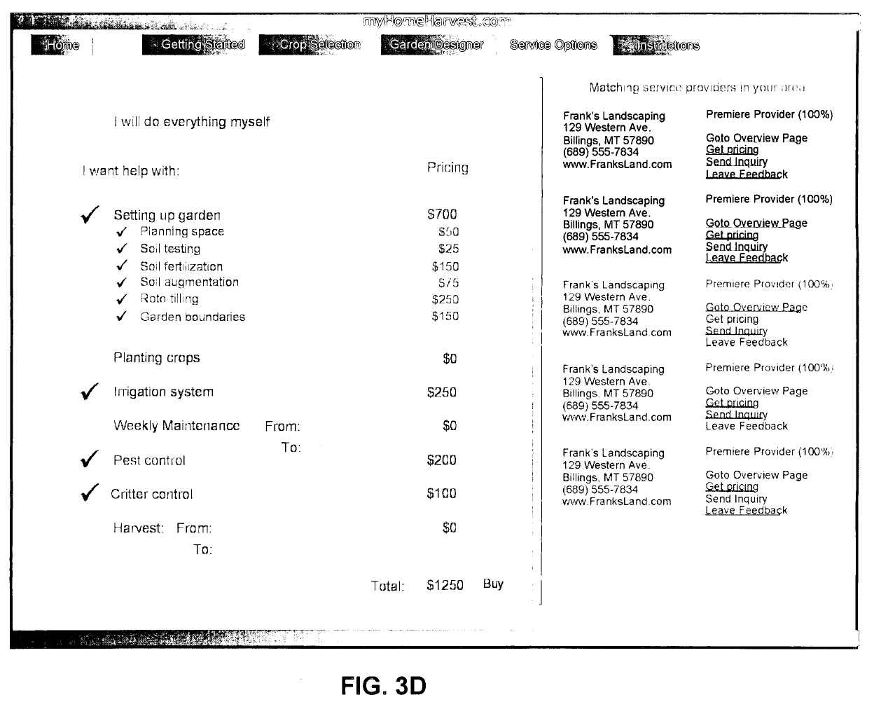

The user interaction module 106 comprises any logic, functions, rules, or operations to provide any type and form of user interface for the user to interact with the system. In some embodiments, the user interface comprises any graphical user interface having a plurality of user interface elements arranged and combined in any suitable manner to receive input from a user and/or display output, data and information to the user. For example, the user interaction module may provide any of the user interfaces depicted in FIGS. 3A-3D and perform any of the functionality, features or operations provided via these user interfaces. In one embodiment, the user interface module comprises a software application for interacting with connected users and responding to requests for features and functionality of the system by the users. Embodiments of the user interface module 106 and the user interfaces provided by this module may change frequently based on improvements to or maintenance of the system, updates of new content, changes to existing content, updates of new features/functionality and/or changes to existing features/functionality. In other embodiments, the user interface module 106 may provide any type and form of command line interface, such as for an administrator to interact with the system.

The intelligent garden designer 107 or garden design engine 107 comprises any logic, functions, rules, or operations to provide an environment and process by which a user interactively designs, generates, customizes or otherwise determines a user desired or user determined garden. In one embodiment, the intelligent designer 107 comprises a web application having one or more modules for garden layout, garden crop, plant or produce selection and gardening instructions. The intelligent garden designer 107 provides the logic, function or operations for a user to design a layout of a garden, including size, shape, orientation, location and number of components or elements thereof. The intelligent garden designer 107 provides the logic, function or operations for a user to determine any element or portions of a garden such as determination and selection of any crop, plant, product, flower or other plantable element of the garden. The user may select any plantable element of the garden based on layout, size, soil conditions, climate or weather conditions, geographic location, yield, costs, aesthetics, nutritional value, intra-garden plant compatibility, ease or difficulty of installation and/or maintenance, etc.

The intelligent garden designer 107 may comprise logic, function or operations for a user to arrange, organize or place any one or more plantable elements or elements of the garden in the garden layout. The intelligent garden designer 107 may provide an interface for a user to section or segment the garden layout into portions for which a garden element may be placed or installed. The intelligent garden designer 107 may also include logic, function or operations to provide information, criteria and/or filters for a user to select the plantable item and/or the placement or arrangement of any element of the garden element, such as the number/size of each garden element and the placement and/or location thereof in the layout. The intelligent garden designer 107 may provide an interface for a user to design and place any non-plant items, such as fence, fence posts, maintenance related equipment, non-planted garden elements, such as statutes, stones, flags, etc. The intelligent garden designer 107 may provide an interface for a user to browse or search for plants, flowers, crops or any element of the garden based on any type of filter or criteria.

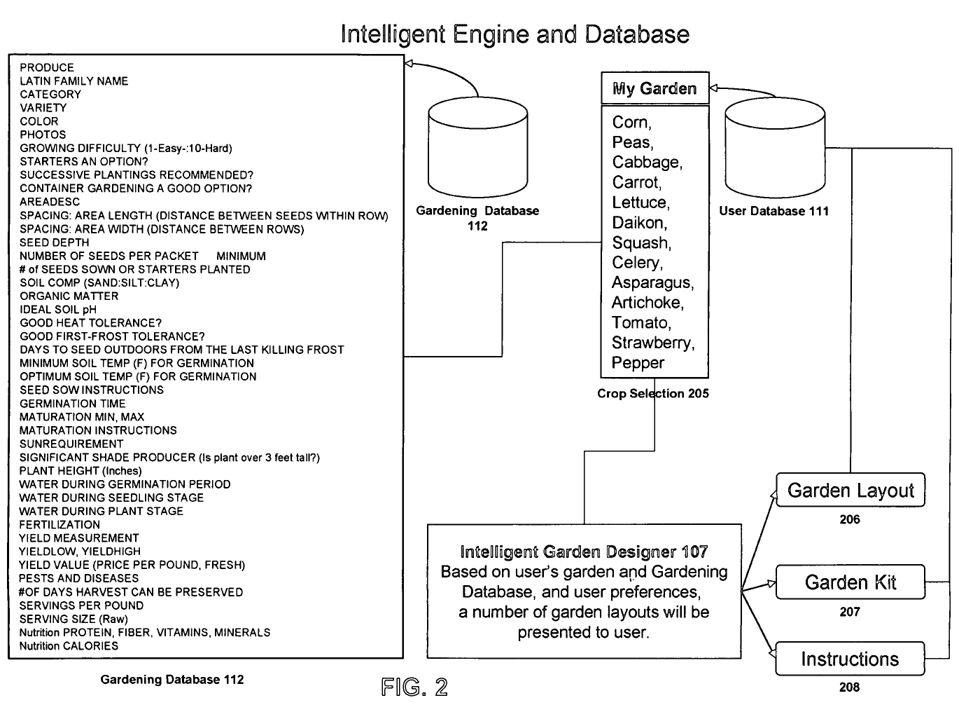

The intelligent garden designer 107 may include any type and form of algorithms, techniques, methods, computations, functions or operations to improve, optimize or otherwise aid and guide the design process of the user. For example, the intelligent garden designer 107 may optimize a garden layout, selection of plantable items for the garden, and size, location, orientation and proportion of each item in the garden based on any criteria of the user, such as crop yield (by volume, value, etc), aesthetics, nutritional value, maintenance, installation, climate conditions, soil conditions or any other environmental conditions, etc. The intelligent garden designer 107 may provide any templates of garden layouts and garden elements based on any number of pre-selected criteria. For example, the intelligent garden designer 107 may provide a garden template for a predetermined geographic region, predetermined soil type, predetermined climate conditions, predetermined yield, predetermined health or nutritional value, favorable aesthetics or based on user favorites or most used designs or design elements. The operation of the intelligent garden designer 107 is explained in further detail in conjunction with FIG. 2.

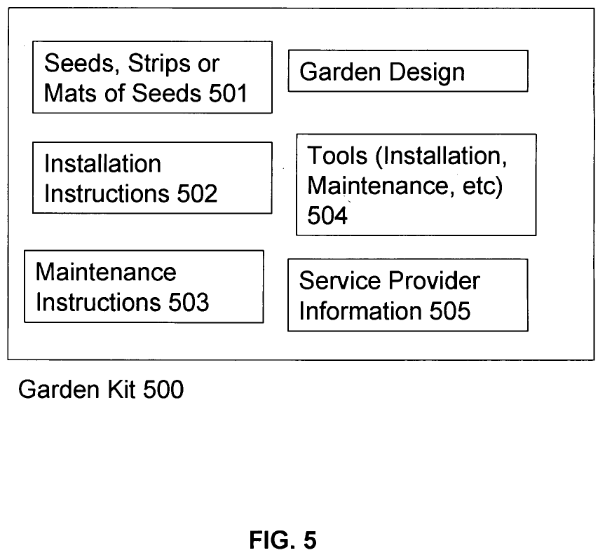

The garden kits ecommerce application or module 108 comprises any logic, functions, rules, or operations to provide users with an interface to select, order and pay for one or more products and/or serviced provided via the system, such as a garden implementation kit based on a garden design of a user determined via the web application. In one embodiment, the ecommerce application comprises a web application having one or more modules that provide users with a customized or user determined garden implementation kit based on a user select garden design. For example, via the ecommerce application 108, the user may select, order and pay for a garden kit 500 designed via the system, such as the garden kit 500 illustrated in FIG. 5. A garden kit 500 provides the user with materials for the garden in a orderable and shippable product form. Upon receipt of the garden kit, the user can plant and maintain their user designed and/or selected garden design. Via the ecommerce module, the user may select and place a garden kit 500 based on a garden design in an online shopping cart for quick and easy checkout. In another embodiment, the user may be provided a list of products to purchase. In some embodiment, the user may order via the ecommerce application 108 a turnkey garden kit. In other embodiments, the user may order any of the embodiments of the garden kit 500 described in FIG. 5.

The ecommerce application 108 may provide any type of interface, functionality and operations to handle different forms of payments, different shipping methods, user registration, user preferences and any other functionality and operations of a shopping cart and/or online purchasing system. The ecommerce application 108 may provide any type of interface functionality and operations to show the status of payment, order processing, shipment, etc. The ecommerce application 108 may provide any type of interface functionality and operations to handle or process customer inquiries, customer support, returns and return authorization, etc.

The services marketplace application or module 109 comprises any logic, functions, rules, or operations to provide an interface for finding and/or communication with any type and form of service provider, for example, a service provider to install and/or maintain a garden. In one embodiment, the services marketplace application 109 comprises a web application for finding local service providers to help install, plant and maintain a garden. In one embodiment, users, via the services marketplace 109, can select the individual services they require or desire and get a list of companies that provide those services near, around or otherwise in the user's zip code (see FIG. 3D for example). In another embodiment, the user selects one or more services for a garden and via the service marketplace automatically gets a list of companies that service their zip code as well as a price quote from each company for each service. In some embodiments, the service provider may provide a price quote or a user may receive a price quote, automatically or otherwise, based on the garden design, such as on a per sq ft price. In yet other embodiments, the service marketplace 108 provides an interface for a user to received multiple bids or quotes from a service provider, based on schedule, price, service components, ratings, etc. and/or based on one or more garden designs of the user.

In some embodiments, the service marketplace provides logic, functions, rules, or operations to arrange, organize, list, rate, rank, or provide other criteria for finding and/or selecting one or more service providers. In some embodiments, the service marketplace provides an interface by the user may view past-customer comments and/or ratings posted for a service provider. The service marketplace provides logic, functions, rules, or operations for service provides to advertise or offer their services, such as in auction type setting or environment similar to EBAY. In another embodiment, the service providers may advertise or offer a set of services other than those used to install, plant and maintain a produce garden. For example, a service provider may advertise their lawn care services.

The gardening notification application or module 110 comprises any logic, functions, rules, or operations to provide communication, information or notices to a user related to their use of the system and/or the installation and maintenance of the garden, and/or their use of a service provider. In one embodiment, the gardening notification application periodically sends messages to users based on their garden designs and other factors such as the time elapsed since planting. In one embodiment, the gardening notification application comprises one or more software modules to automatically check each user's garden design to determine if any notable event has or will soon take place. For example, gardening notification application may send out notices via email, telephone, SMS, text messages, fax, or otherwise regarding any maintenance related activity of the garden, such as the time for harvesting of a particular crop or the time that crops should be weeded or other maintenance. Another example is the recommended, suggested or best time for planting a particular crop in the garden design. The notification system generates emails or other forms of communication having information pertinent to the user's garden designs on a periodic basis. In one embodiment, the user chooses how often, at what time and/or in what format to receive these notifications. In another embodiment, the user chooses which types of maintenance activities for which to receive notifications. In some embodiments, these automated reminder and informational emails may be sent to the service company chosen by the user to perform services related to their garden design.

The system may include and the web application may use one or more databases to store, track, manage and provide any type and form of data related to the use of the system and the user's garden designed therefrom. Still referring to FIG. 1, these one or more databases may comprise a user database 111, a gardening database 112 and/or a service provider database 113. Although these databases may be referred to separately or as separate databases, the user database 111, gardening database 112 and service provider database 113 may form a single database. In some embodiments, these databases may be part of a database farm or a cluster of databases distributed to or operating on one or more servers. In other embodiments, each of these databases may comprise a group of one or more tables or database structures in a single database or otherwise in a plurality of databases. Any of these databases may comprise any type and form of storage system, including relational, object based, object oriented databases, files, file systems, memory based storage and/or applications.

The user database 111 comprises storage of any type and form of user information and data. In one embodiment, the user information includes contact information of the user such as name, address, telephone, email address, etc. The user database 111 also stores, tracks and manages any data and information of one or more garden designs of the user, such as any of the garden design information for one or more gardens. In one embodiment, the user database stores information on a designed garden such as the size of the garden, the crop selections, the garden layout, the date each crop is planted, the projected and actual yields, the dates of harvesting and/or the amount of projected and actual yields. This database 111 would also include user account management such as user name and password, a history of purchases and personal preference selections. The system and the database supports any type of user including residential, commercial, industrial, educational, institutional and governmental. The system and the database also further supports any size, shape and orientation of a planting space. The system and the database further supports one or more such planting space, or garden designs per user.

The gardening database 112 comprises storage of any type and form of data and information related to a garden and any portions thereof. In one embodiment, the database includes detailed information for any crop, plant or element of the garden supported by the application. The database may include data providing a crop's specific properties, growing characteristics, yield, environmental requirements, maintenance and installation requirements, nutritional content and other related information. The system supports any type of crop including flowers, vegetables, fruits, bushes and trees. The system supports any garden element that is grown or plantable as well as any non-plantable elements that may be used in support of or with a garden.

The service provider database 113 comprises storage for any type and form of information and data related to a service provider, such as via any of the functionality of the service marketplace module described above. In one embodiment, the database stores information about each service provider such as business information, marketing and/or advertising information, contact information, products and/or services provided, zip codes serviced, past customer comments, ratings, pricing, transaction history, schedule/availability and the like.

Referring now to FIG. 2, a block diagram of an embodiment of an intelligent garden designer 107, also sometimes referred to as an intelligent engine of the web-based application is depicted. In brief overview, the intelligent engine 107 is in communication with a gardening database 112 and a user database 111, to generate and present one or more garden layouts 206, garden kits 207 and instructions 208 based on a user interactive design process. The gardening database 112 includes a database of gardening knowledge. The user database 111 includes a database of user crop selections, and garden layouts. The intelligent engine 107 includes a web application for automating and supporting the process of selecting items to plant, deciding how to the place the items within the garden space, and complete instructions for planting, maintaining and harvesting any crops.

In some embodiments, the gardening database 112 comprises data and information specifying, describing, representing or otherwise provide details for each crop and plant supported by the system. In further details of gardening database 112, the database may provide a very detailed set of information to assist in the process of selecting the right plants and crops for a garden, how best to plant each crop, how best care for and maintain each crop, how best to harvest, how best to use, and how best to store each. As depicted in FIG. 2, the database may include information, such as a produce or crop name, latin family name, category, variety, color, photos, growing difficulty, etc . . . to servings per pound, serving size, and nutrition information. The database may also include a growing set of plants and crops. The database is not limited in the number of plants it may support.

In further details of gardening database 112, the database may expand and improve over time. The database may improve over time based on feedback of actual garden implementations to enhance the accuracy of the information. In another embodiment the database improves over time based on research and other factors that enhance the accuracy of the information. In another embodiment, additional details are added to the database for each crop and plant to enhance the usefulness of the site, the user experience, the yield of the crop and the accuracy of the information.

The user database 111 may include details about the user, the user's activity on the web site and the user's garden designs. For example, as show in FIG. 2, the user database may include the crop selection 205 of a user garden design referred to as “My Garden”. The “My Garden” design may include corn, peas, cabbage, carrot, lettuce, daikon, squash, celery, asparagus, artichoke, tomato, strawberry, and pepper.

In further details of user database 111, the user makes selections of plants and crops for his garden which are stored in the User Database 111. These crop selections are used to design the garden layout. In one embodiment, the user makes his selections of crops based on a variety of sort options provided by the system (see FIG. 3B). In this embodiment, the user may make these selections before moving ahead to the garden layout step. In another embodiment, the system provides or offers a variety of pre-defined crop selections for the user to choose from. These pre-defined crop selections may be optimized for various purposes such as ease of planting, good nutrition, maximal yield, balanced harvesting and others. In another embodiment, the user can choose from a set of pre-defined crop selections created by other users. In another embodiment, the user can choose from a set of pre-defined crop selections created by “expert” or “celebrity” gardeners, nutritionists or chefs.

The crop selection 205 comprises, in one embodiment, a list of crop and plant selections made by the user which are stored in a database. This crop list defines which crops will be planted in the garden being designed. In one embodiment, the user is presented with a set of thumbnail images represented each available crop based on their growing zone. These thumbnails may be selected to display additional information specific to each crop (see FIG. 3B). The data that is shown for each crop may be obtained from the Gardening Database 112. This data may be presented in a way that assists the user in making an informed decision about whether or not to include the crop in the garden being designed. In another embodiment, additional reference information is made available such as recipes related to the crop and community information such as comments from other gardeners, nutritionists, chefs or others.

In further details of Intelligent Garden Designer 107, the user is initially presented with an automatically generated garden layout based on the user's selection of crops to produce optimal yield (see FIG. 3C). The user can modify the layout by choosing other factors to base the layout on such as ease of planting, maximizing monetary value, or by increasing the amount of individual crops or crop types. For example, the user may choose to increase the yield of “herbs”, or to decrease the yield of “salad crops”, or specifically carrots.

In further details of Intelligent Garden Designer 107, the user is provided with details relevant to the garden design including the total yield of each crop, total monetary value of each crop and all crops, the total servings of each crop and all crops, the total cost of each plant and all plants (see FIG. 3C). These details are updated as changes are made to the garden design. In another embodiment, the intelligent garden designer 107 provides the initial garden layout to the user based on other user's designs or “expert” designs by professional gardeners, nutritionists, celebrities, or chefs.

Via interaction with the user or based on user selections, the intelligent garden designer 107 generates or otherwise provides a garden layout 206, a garden kit 207 and/or instructions 208 based on a garden design. The garden layout 206, garden kit 207 and instructions 208 may be stored as data and information in any of the databases. The garden layout database may store information of the user's garden designs and layout information, such as a history of garden designs for each user.

The garden kit database 207 comprises, in one embodiment, data and information representing or otherwise providing a gardening kit, such as the garden kit 500 of FIG. 5, which may include all seeds and other products for planting and maintaining the garden design. In one embodiment, the system automatically places the kit into the user's shopping cart for ease of purchase.

The Instructions 208 may comprise data and information to provide implementation instructions, such as installation and maintenance instructions, for the user's garden design. These instructions may include any instructions related to the end-to-end lifecycle of a garden, such as a comprehensive set of instructions for the user to establish, plant, maintain and harvest the garden design. In one embodiment, this instruction set is sent to the user via email. In another embodiment, this instruction set is made available to the user on the web-site any time they are logged in. In another embodiment, this instruction set is broken apart into smaller sets of instructions and made available to the user via email or on the site. In another embodiment, these instructions are emailed to the user when the information is most relevant, such as just prior to when an action is required. In another embodiment, these instructions are sent to the service provider selected by the user to perform services related to their garden design. In another embodiment, the user is sent an email to click a link to the site to provide implementation feedback such as the date which user planted the garden or specific plants within the garden. Another example of implementation feedback is to specify any deviations of the implementation of the garden from the design of the garden created with via the application. This feedback may be added to the user's Garden Design database 112 and may affect the details and timing of further instructions or other instructions.

Referring now to FIGS. 3A-3D, embodiments of user interfaces of the application are depicted. In brief overview, FIG. 3A depicts one embodiment of a home page for the garden design web site. FIG. 3B depicts one embodiment of the crop selection user interface. FIG. 3C depicts one embodiment of the Garden Layout tool. FIG. 3D depicts one embodiment of the services marketplace user interface. Any of these interfaces may be displayed via the user interaction module described in FIG. 1, or via any other modules of the web application.

In further details of FIG. 3A, this user interface is an example embodiment of a user interface to convey the benefits and value of the site and allow the user an easy way to learn more and to make full use of the tools provided. Via this web-page or user interface, the user may learn about recipes, tips and techniques for gardening and see other user and garden designs. The user may register to the site and may visit his account information to start the design process or review and modify any previous garden designs. The web application may provide a community based content where users can share and comment on information related to the application, gardens and other related gardening items of interest. Via this user interface, the user may browse and learn about service providers and provide feedback about service providers. Furthermore, service providers may register to join the web-site to offer and advertise their services. In some embodiments, the user interface provides, offers or advertises one or more product or service specials.

In further details of FIG. 3B, this user interface displays and provides information for each crop supported by the system, such as educational information on a crop. In some embodiments, the user interface displays any of the information and data available in the gardening database. The user interface of FIG. 3B aggregates, organizes and presents a plurality of details of a crop in single place or concise view and in an easy to access format. The user interface may provide user interface elements to sort the crop information by any one or more criteria or filters. For example, as illustrated in FIG. 3B, a user may sort crop information by name, yield, value, ease of growing, maturation time, soil match, nutritional value, most to least popular, hardiness and/or shade tolerance.

One benefit of this application is that growers or users are more informed about which crops are right for them or which crops to include in a garden design. Another benefit of the application is the user has more comprehensive understanding of the crop before growing it. Another advantage is to expand the number of crops planted for an individual garden as growers will have greater knowledge, confidence and support through the process. The embodiment of the user interface of FIG. 3C illustrates a tool to provide visual garden design and layout. The user can arrange, orientate and design the layout to place selected crops in any portion of the garden layout. The user can design the number of each crop to place in the design and at which location. The user can add new plants and/or remove plants from the design. The user may select 3D and/or 2D views of the garden. The user may also change the size of the garden. Furthermore, the user may optimize the garden according to yield or space using any of the command buttons provided by the user interface.

By providing a visual presentation of the garden that approximates, to scale, the garden being designed, users are better prepared for the implementation. Further, by allowing users to interactively design their garden based on various factors and see changes reflected visually, this process offers an engaging, if not entertaining, aspect of gardening heretofore unknown.

Referring now to FIG. 3D, this user interface provides users an interface to access service providers, such as to match their needs with the offerings from local providers. The user interface provides user interface elements for the user to select which service activities related to the garden for which the user seeks quotes or information from a service provider. The user interface provides users with a list of potential service providers, accessible profiles, and price quotes, such as immediate price quotes. The service providers may be listed by any type of order or ranking, alphabetical, distance from user, price, ratings, comments, etc. The user may also view comments left by previous customers of the service providers. Via the user interface, the user may purchase one or more services from one or more service providers. The system may communicate the information of selection of services and garden design to each of the one or more services providers.

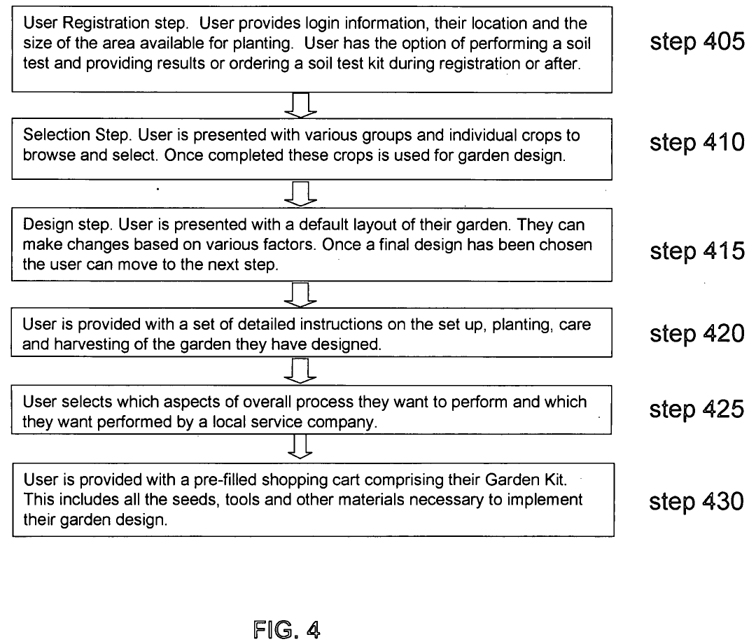

Referring now to FIG. 4, an embodiment of steps of a method for planning, designing and implementing a garden using the system of the present solution is depicted. In brief overview, at step 405, the user registers with the site by providing contact information, such as a name and zip code. At step 410, the user makes selections of crops and plants for their garden. At step 415, the users design the layout of their garden. At step 420, the user is provided with a set of instructions for the preparation, planting, maintenance and harvesting of their garden. At step 425, the user decides how much of the implementation they will do themselves versus being done by a services company. At step 430, the user is provided with a shopping cart having one or more of the products needed to implement their garden.

In further details of step 405, in one embodiment, the user is presented with a form to be filled out requesting various personal data, such as via the user interface illustrated in FIG. 3A. In another embodiment, the form may request credit card information or other payment information. In some embodiments, the application provides a form for users to sign up for “crop of the day”, or “crop of the week” emails. If selected, then the user may receive a specially formatted email based on the frequency chosen with detailed information about a particular crop. The user may also provide information on their location, such as via a zip code, and the size of the area available for planting. The user may provide results of a soil test or order a soil test kit.

In further details of step 410, in one embodiment, the user is presented with a list of crops and plants supported by the system to browse. This list may be provided visually with thumbnail pictures of each crop along with its common name. The user can learn more about the crop by clicking its thumbnail or other selectable user interface element associated with the crop. The system presents detailed information on the screen, such as in a highly or easily readable format. In one embodiment, all of the relevant information of the crop may be formatted to fit on the screen. In another embodiment, the available information is provided under tabs that user can select. Each tab may represent a category of information (e.g., planting, harvesting, using, nutrition, storage). In another embodiment, the screen provides a set of links or Uniform Resource Locators (URLs) to other sites providing additional information related to the crop.

The application provides a discovery center for anyone interested in learning more about crops, plants, fruits, vegetables, herbs, flowers, trees and other growing things. This embodiment of the web-site or web application may offer a wide array of information and ways to view the information on the above growing things. In one embodiment, the user can select a number of plants to “compare” the relevant details of each. In this embodiment, the user may be provided with a matrix or grid of information to easily compare the details provided. In another embodiment, the user can enter search terms to find relevant crops. For example, the search term “beta carotene” may result in a list of crops including carrots, kale, and chard

In further details of step 415, the application may provide the user with an automatically designed or default layout for their garden space The automated layout algorithms may be based on a variety of factors such as maximizing yield, yield value, space, or simplicity. The user is presented with a visual representation of their garden scaled to fit the screen. In one embodiment, the garden layout is presented in two dimensional graphic representation. In another embodiment, the garden layout is presented in three dimensional graphic representation.

In other embodiments, the user designs the garden layout using any type and form of drawing tool or design layout manipulation tool. The user may create or design any shape, size and orientation of garden or modify any provided template or default layout.

At step 415, the application via the user interface provides tools for easier and simpler interaction for optimizing and customizing the garden layout and plant quantities. The user is presented with a set of information for each crop and for the entire garden that reflects the current layout. In one embodiment, this information includes the projected yield of each crop by weight and number of meals and the monetary value of the yield. These per crop value may be summed to provide the totals for the designed garden. In another embodiment, the user is also provided with additional details including costs, difficulty level, risk levels, storage options, and further details that might aid in the design process. In one embodiment, the user can change the amount for a crop simply by clicking an icon representing “more”, and can reduce the amount for a crop simply by clicking an icon representing “less”. The layout may be automatically re-designed to reflect the selection.

In another embodiment, the user can modify the garden layout by clicking various options to re-focus or re-purpose the garden. For example, the user can click an option to increase the “salad” crops, whereby the crops meant for salads would be increased accordingly. In another example, the user could click the “storage” selection and those crops with easier storage options would be increased. In another embodiment, the user can select the degree to which the space is optimized for maximum yield. On one end of the scale the space between rows is generous for easy movement and access and crops are positioned in a way that creates simple garden layout. On the other end of the scale, spaces between rows is minimized and crop placement is optimized for maximum yield. For example, there are many plants that will do well placed between tomato or other taller, shade plants. When maximum yield is chosen then such placements will be used in the layout. This optimization scale may have a number of positions along the scale to choose from. In another embodiment, the user can select a “crop rotation” option based on a previously designed and planted garden. If this option is selected, the garden layout will consider the previous planting or plantings to ensure that soil degradation.

In further details of step 420, once the user is satisfied with their garden's crop selection and layout they are presented with a set of instructions for implementation. In one embodiment, this set of instructions is emailed to the user in the form of a PDF file or formatted in HTML. In another embodiment, these instructions are presented to the user on the site and can be accessed any time from the user's account pages. In some embodiments, the user selects the notification option and is sent the instructions piecemeal based on the actions that need to be taken in the coming days. For example, the initial steps for setting up the garden space are sent in early spring. These instructions would be the only ones sent until the user indicates that the step is complete on the site. Once each step is completed, the next step of instructions is sent to the user via email and or available on the site. At the step where the user needs to plant crops, a detailed set of instructions is provided for each crop. Once each crop is planted the user provides the planting date to the site by entering it on the garden instructions site. This date could be provided just once for all crops, or separately for each crop. Once the crops are planted the site would send periodic instructions and reminders via email related to care and maintenance. At this stage it is not necessary for the user to respond to the system to receive further instructions. The system may send timely and relevant information throughout the growing process. For example, if the garden includes carrots, the site will send details about how to harvest carrots. The email may be sent based on the planting date provided and the number of days carrots take to grow in the database. If the user selects a service provider to help implement their garden, then the service provider will also receive the instructions and reminders relevant to the services they will provide.

In further details of step 425, the user chooses which steps of garden implementation and/or maintenance to perform themselves and which steps they want done by a service company. This user interface provides an easy way for growers to find service companies in their area to help them establish, plant, maintain and harvest their garden. In one embodiment, the user is provided with profiles of each service provider to help them make a choice. In some embodiments, the user is provided with comments left by previous customers of the service provider and a rating of satisfaction. In another embodiment, the user can review additional services offered by the service provider (for example, landscaping). Once the user has found one or more service companies they can click the Buy button to initiate contact with the service provider. In one embodiment, payment is collected by the site and remitted to the service provider once services have been rendered satisfactorily. In another embodiment, the financial transaction is conducted between the user and service provider.

In further details of step 430, the user is provided with a pre-filled shopping cart based on a selected or finalized garden design. For example, the shopping cart may include a garden kit product to implement the garden they have designed, such as a complete garden kit 500 with all necessary elements to install or establish the garden. In one embodiment, this shopping cart includes all the seed products, tools, fertilizer and anything else that may be required for the garden. The user may remove things from the shopping cart before checking out. The user could also add additional items to the cart from the online store.

Referring now to FIG. 5, an embodiment of a garden kit 500 provided by using the systems and methods described herein is depicted. A garden kit 500 provides the user with materials (such as seeds, tools, etc) and information (installation instructions, maintenance information, etc) in a orderable and shippable product form. In brief overview, the garden kit 500 may include seeds 501, installation instructions 502, maintenance instructions 503, the garden design of the user, tools 504 and/or service provider information 505. The application may integrate, interface to or communication with any manufacturer or provider of garden kits so that they can manufacture and ship the garden kit 500 according to the garden design.

The garden kit 500 may include any type and form of seeds 501 for the garden design based on the selected plants or crops. The seeds may be organized into strips or mats 501 in accordance with the design. In one embodiment, the garden kit 500 includes seed tape in the correct length, prepared with the seeds chosen for the garden based on the garden layout. For example, a strip of seeds may be provided for each row of the garden having seeds for the type of crops placed at each location in the row. In another embodiment, the garden kit 500 includes a seed carpet customized based on the crop selection and garden layout. This seed carpet allows the user to simply place the carpet in the garden space, cover with soil and water. The garden kit 500 may also include any fertilizer recommended based on the soil test results or other factors, such as the type of crop. The garden kit 500 may also include crop markers for the user to place in the garden to identify where each crop is planted. In some embodiments, the garden kit 500 is optimized to simplify the process of establishing, planting, maintaining and harvesting the garden.

The garden kit 500 may include any type and form of instructions and information for planning, establishing, maintaining and harvesting a garden. The installation instructions 502 may provide information for installing the garden according to the identified garden design and using the one or more strips of seeds. The installation instructions 502 may provide, for example, instructions to clear a plot of land and perform soil testing. The maintenance instructions 503 include information for maintaining the plants and crops specified by the garden design. The maintenance instructions 503 may include, for example, instructions on controlling weed and pest, adding fertilizer and checking the health of plants and crops. The garden kit 500 may be customized for a garden design created or selected by a user. In addition, the garden kit 500 may include one or more gardening tools 504, equipment, material, and other gardening essentials according the garden design. A graphical representation of the graphical design may also be included in the garden kit, such as a poster annotated with plant and crop information.

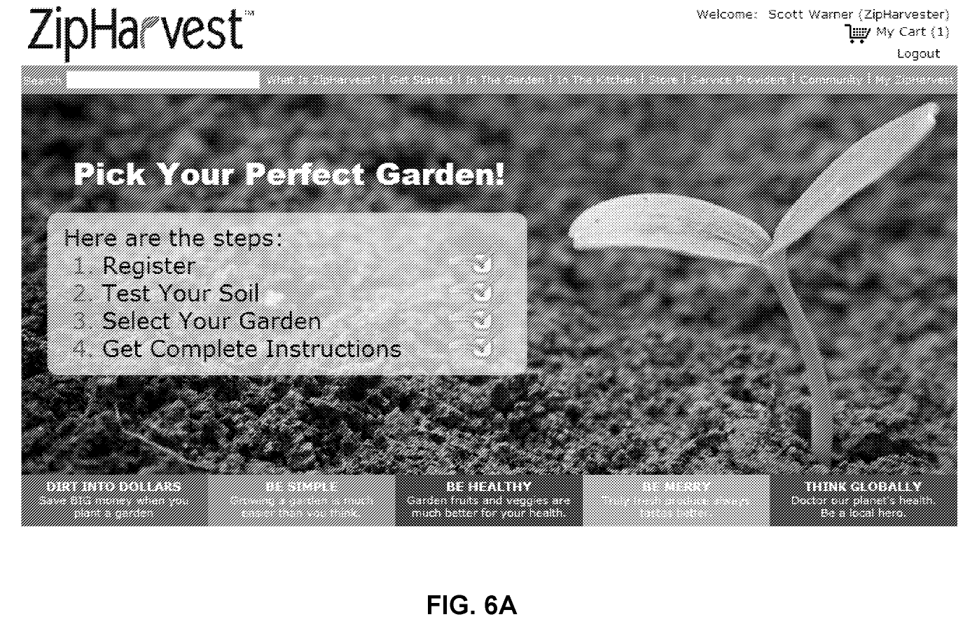

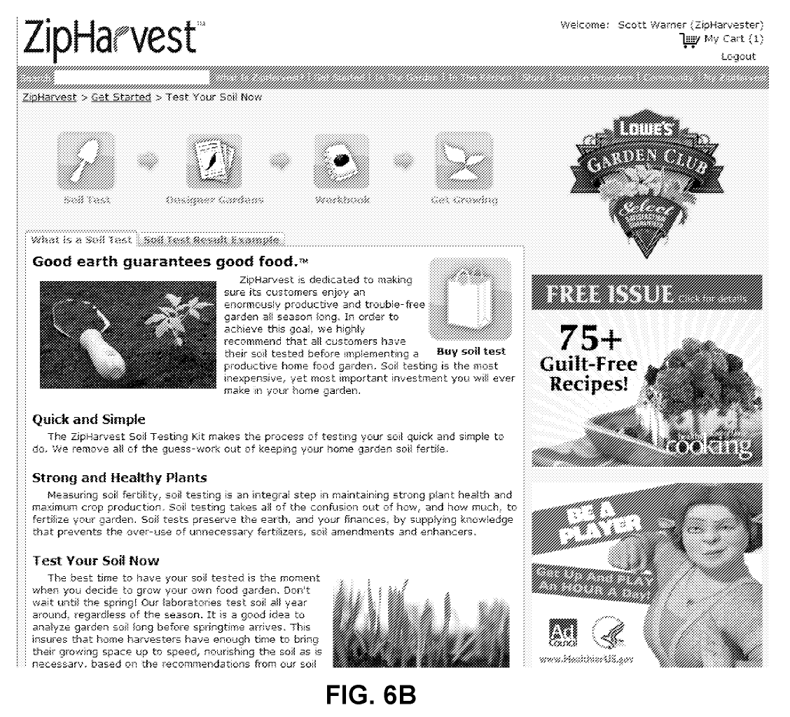

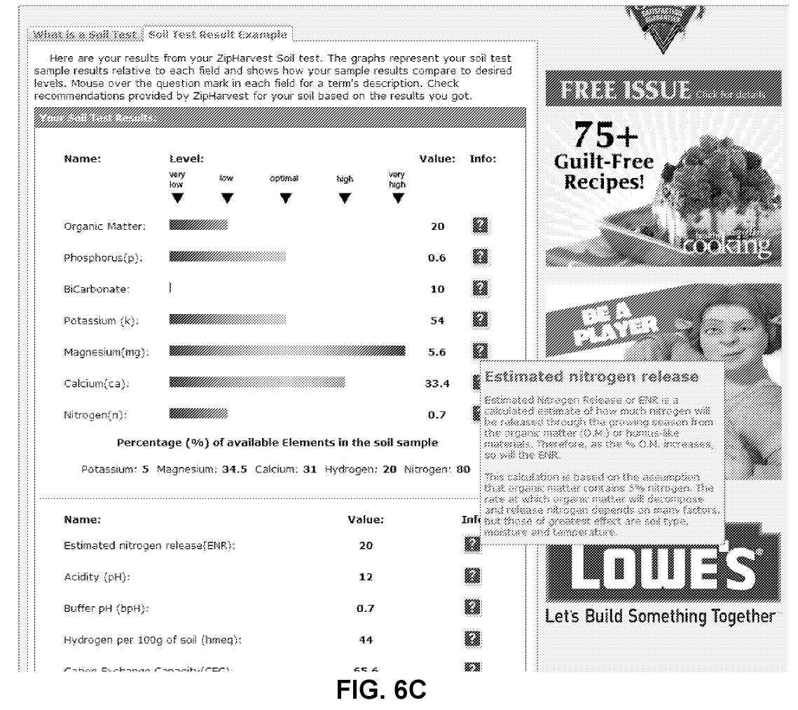

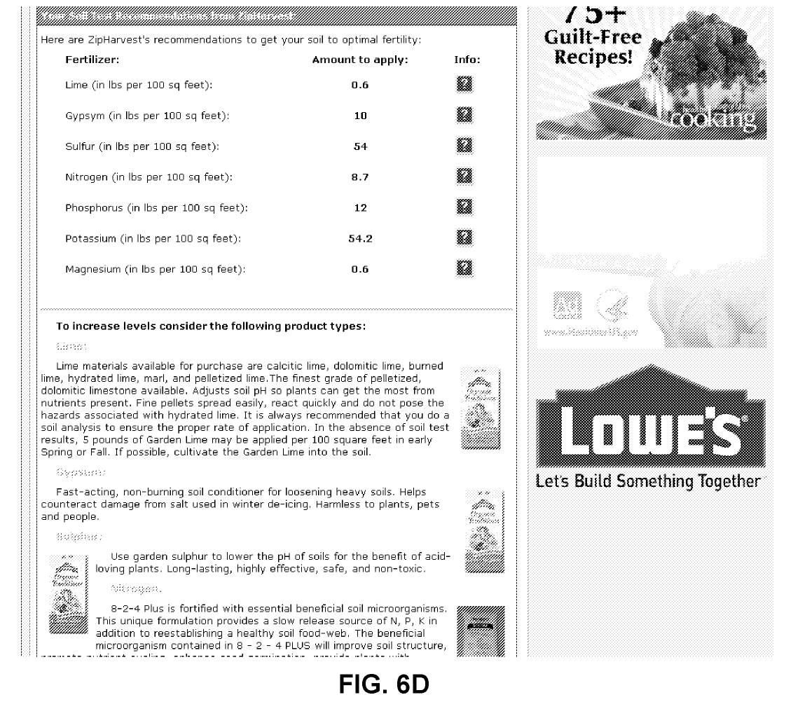

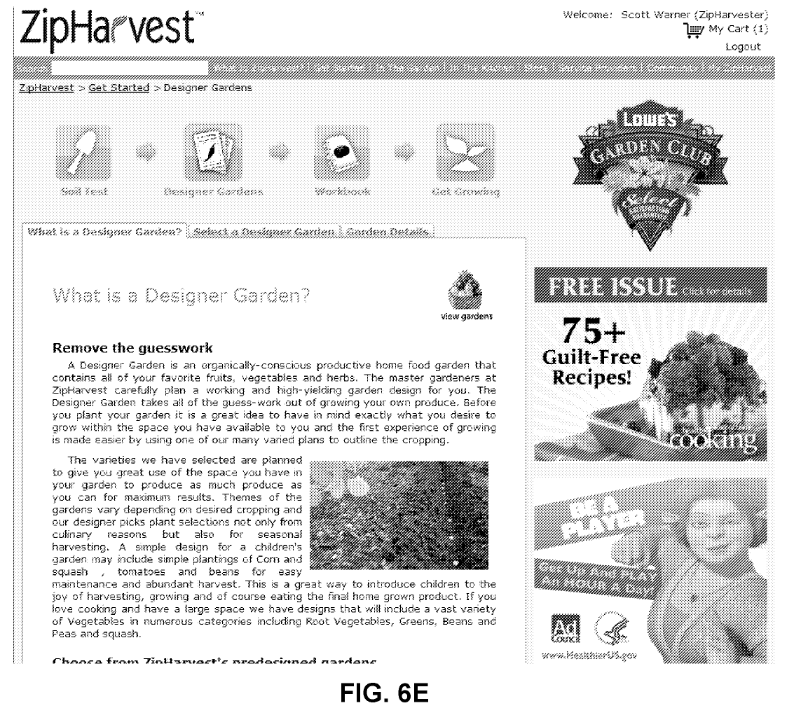

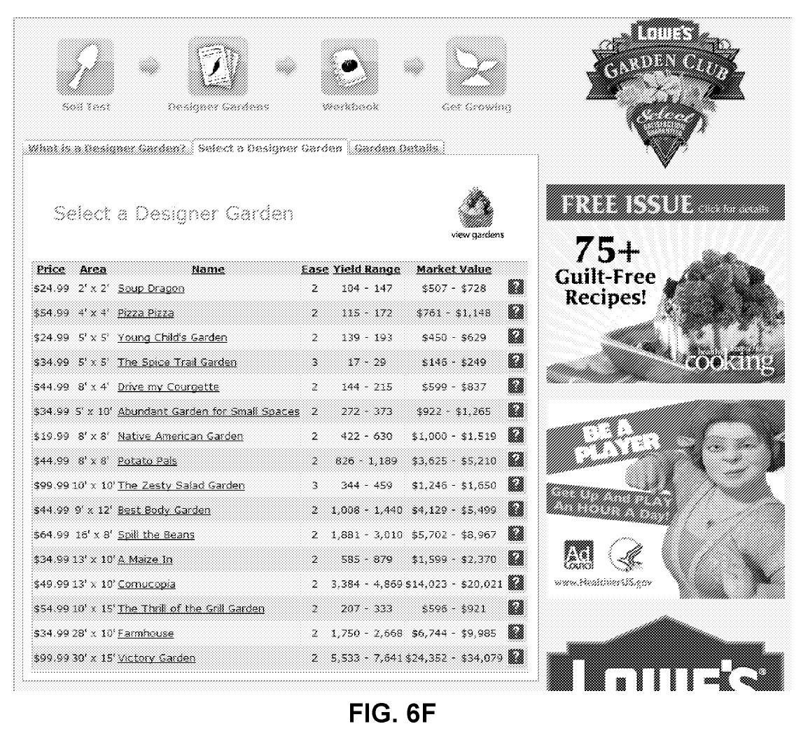

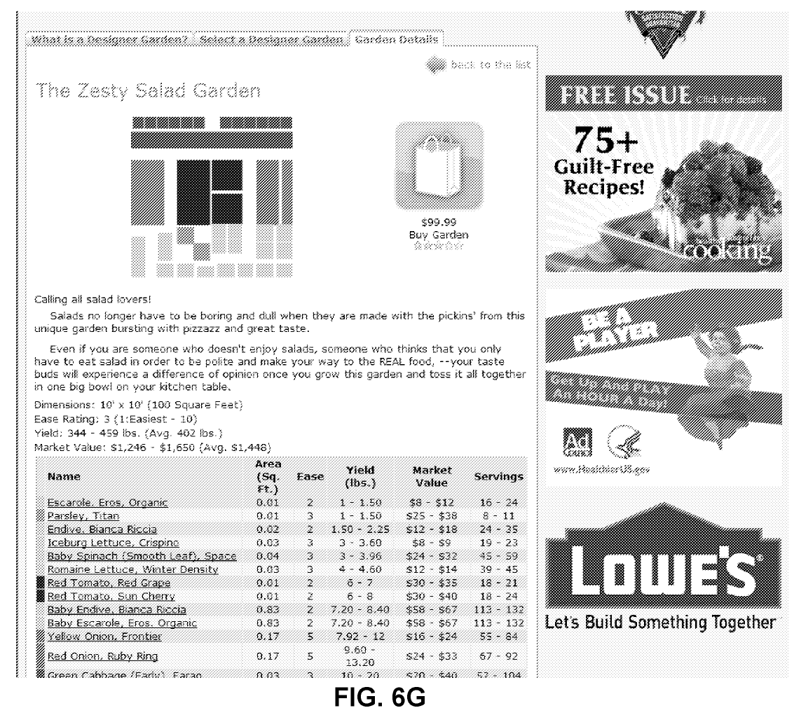

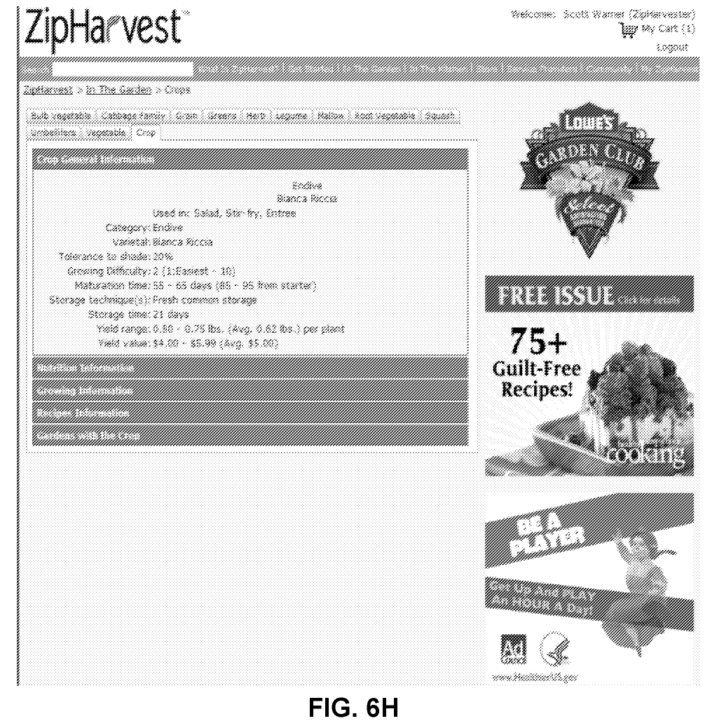

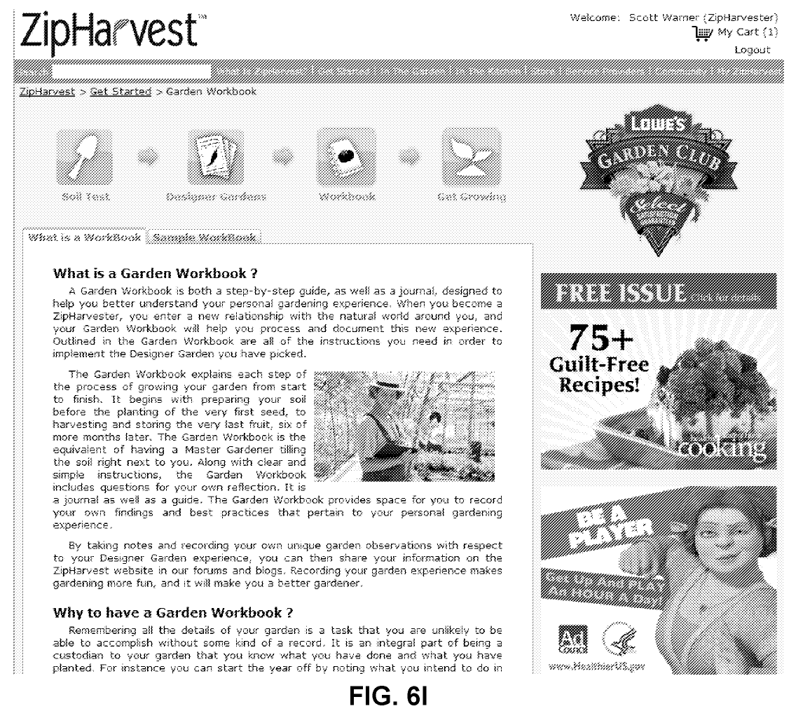

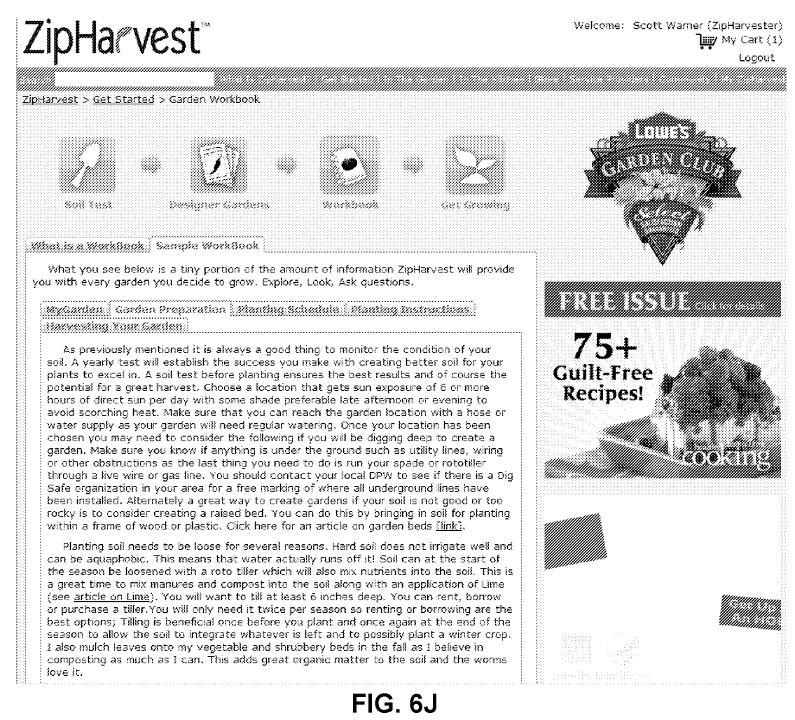

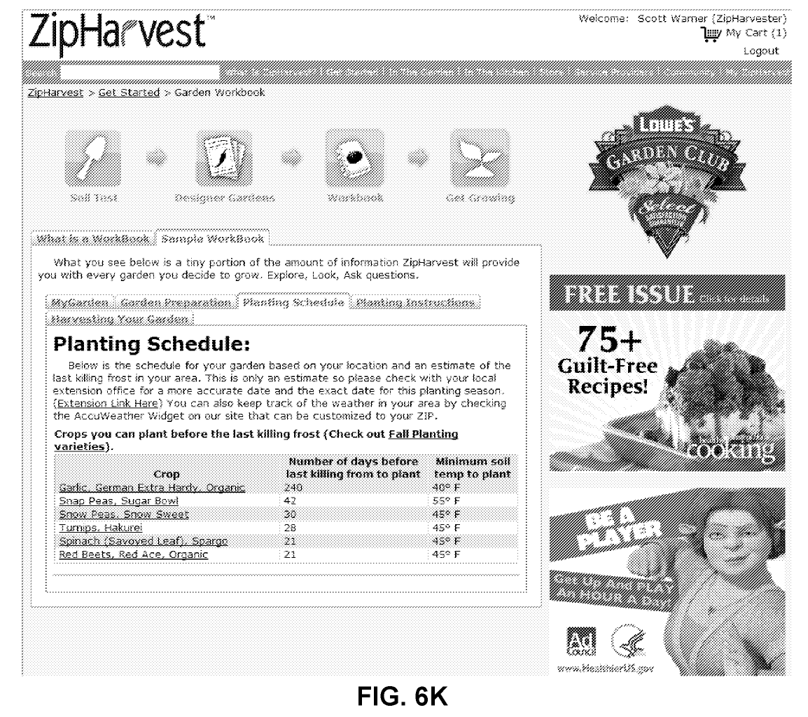

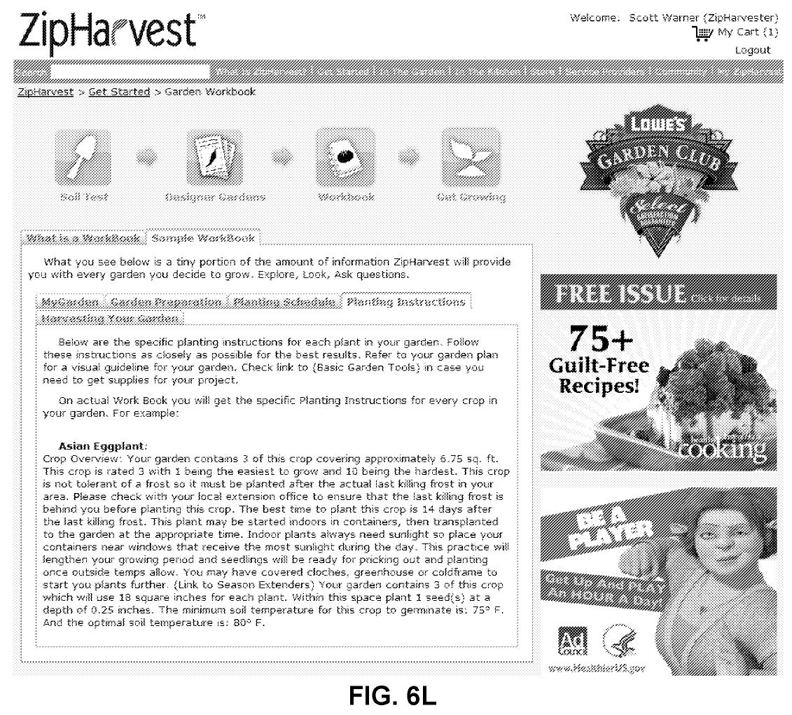

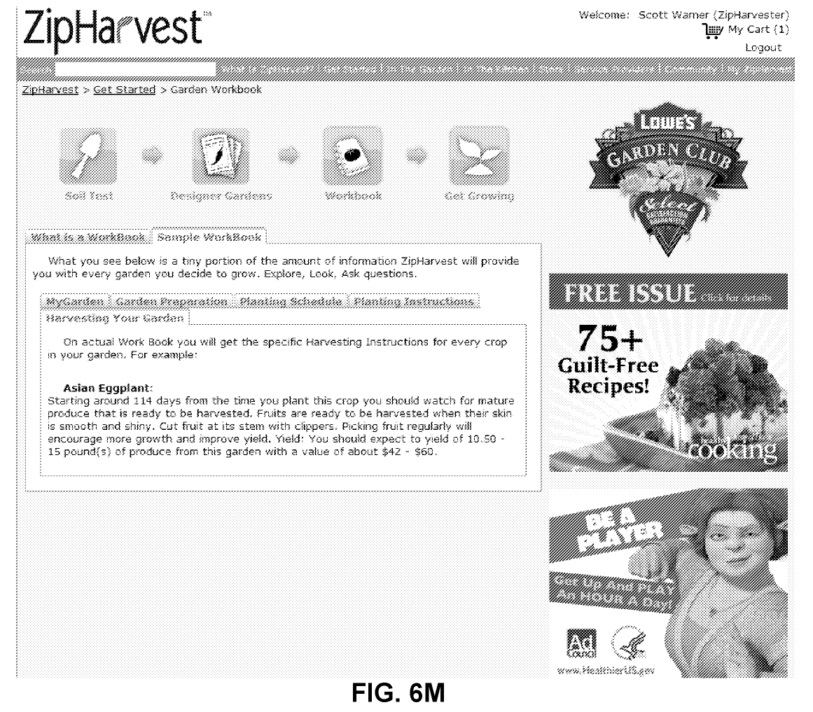

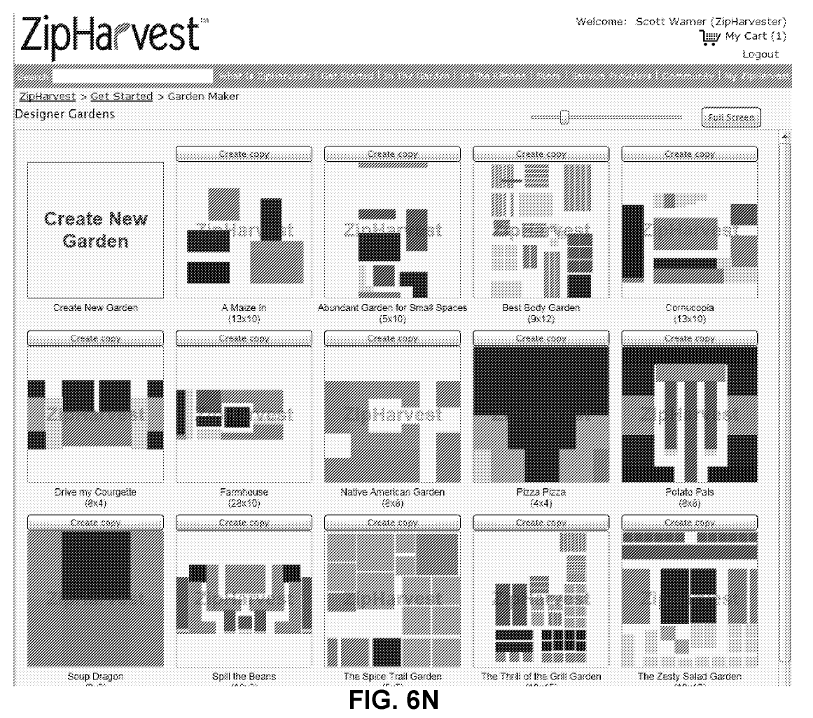

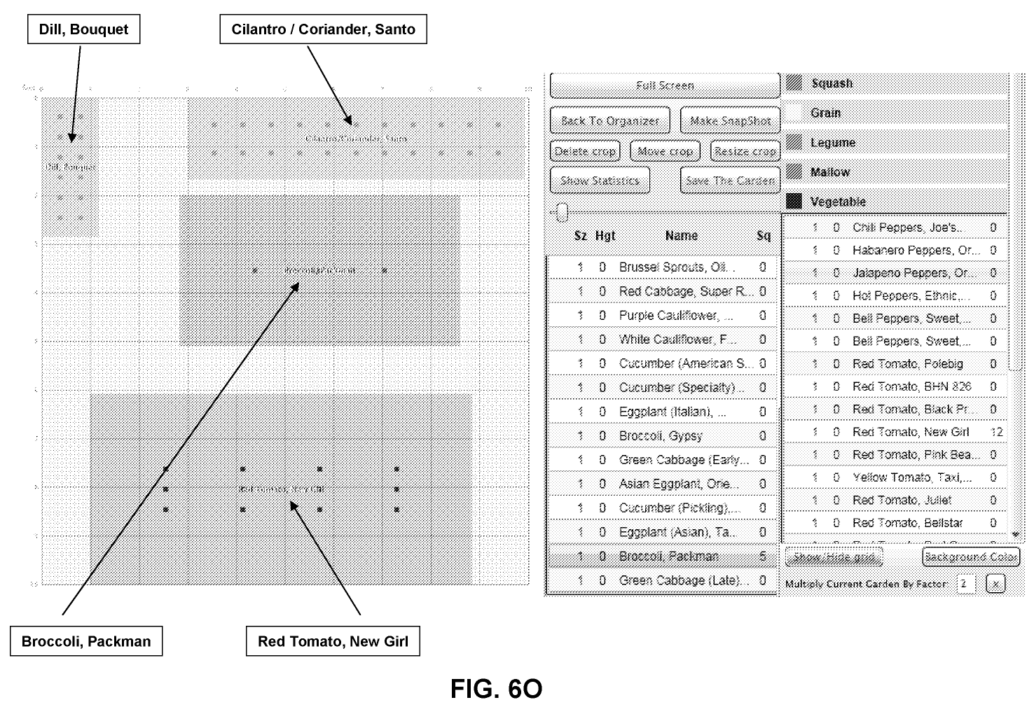

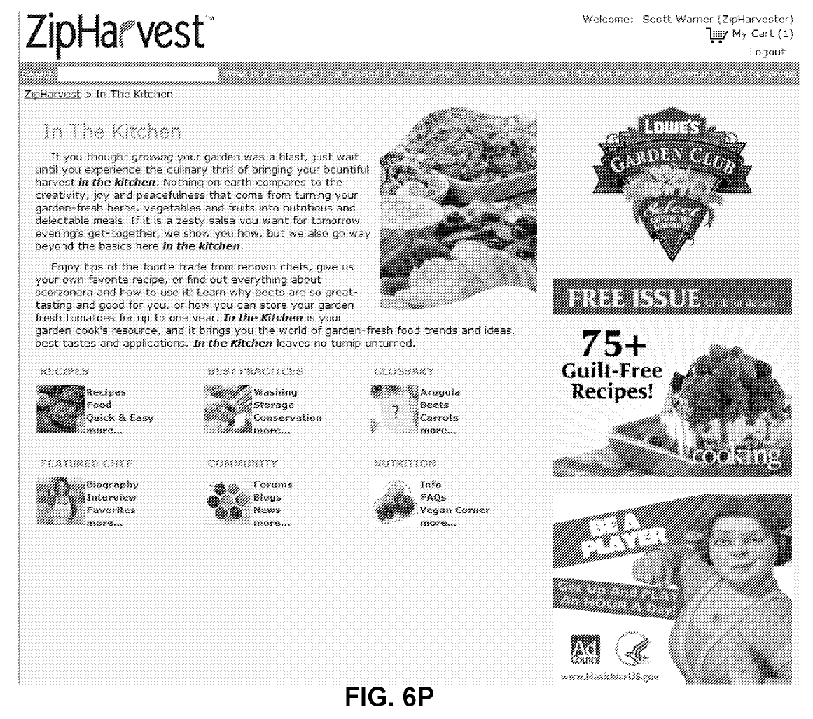

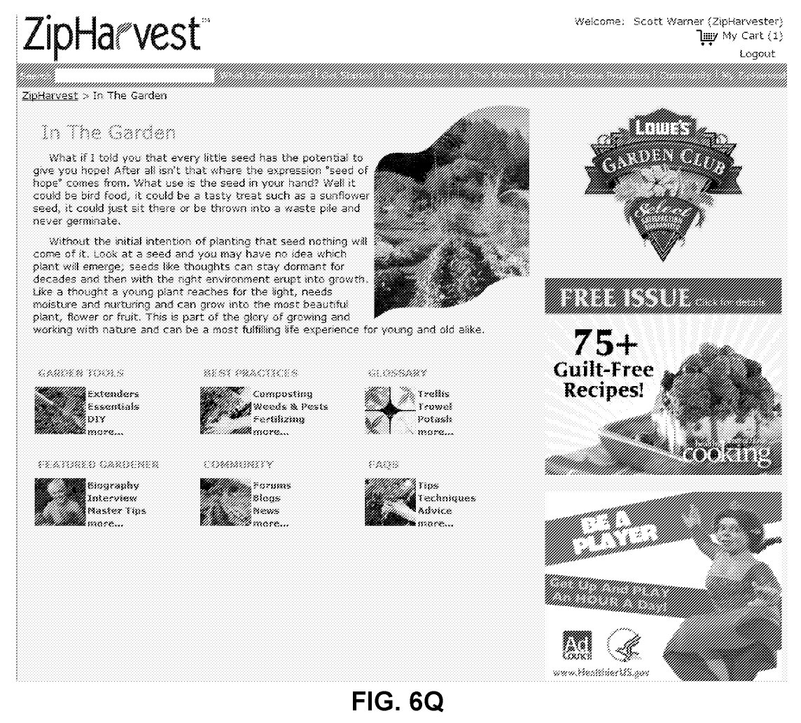

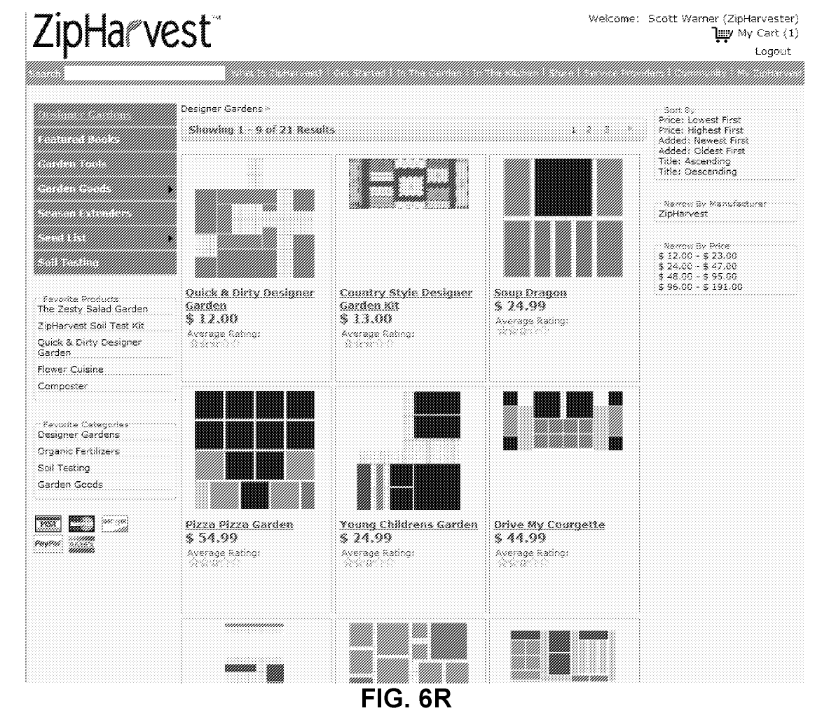

Referring now to FIGS. 6A-6R, embodiments of user interfaces of the web application are depicted. In brief overview, FIG. 6A depicts one embodiment of a home page for a garden design web site provided by the web application. FIGS. 6B-6D depict embodiments of web pages of the web site providing information associated with soil testing. FIGS. 6E-6H depicts one embodiment of a web page providing information about designer gardens. FIG. 6I-6M depict embodiments of web pages providing an online guide and personal journal for enhancing a user's gardening experience. FIGS. 6N-6O depict embodiments of web pages providing a garden designing interface. FIG. 6P depicts one embodiment of a web page for information associated with food preparation and nutritional value of plants and crops harvested from a designer garden. FIG. 6Q depicts one embodiment of a web page for providing information associated with garden maintenance. FIG. 6R depicts one embodiment of a web page for providing a selection of designer gardens. Any of these web page user interfaces may be displayed via the user interaction module described in FIG. 1, or via any other modules of the web application or system.

In further details of FIG. 6A, the user interface is an embodiment of a home page for the garden design website, also described above in connection with FIG. 3A. This user interface may also be an embodiment of an introductory web page to provide an overview of the garden design website. This user interface may be designed to attract and retain a user of the web page, for example, by displaying pertinent and interesting information related to garden design, which may concisely be laid out on the web page. In addition, visually pleasing graphics and a user-friendly user interface layout may enhance the user's experience when browsing the web page, encouraging further exploration of the web page and within the garden design website. In addition, the user interface may provide any form or type of navigable links, icons and graphical objects for easy navigation to other web pages of the web site or related web sites. This may further enhance the user's experience in finding relevant or interesting garden design information, and can provide an overview of the website's contents, features and value.

The user interface may provide any other feature or function to promote the use of the garden design website and enhance user experience. The web application can provide a search function and interface for users to locate information related to keywords of interest, including information from within the web site, from related web sites, and across the internet In one embodiment, the user interface provides a user registration function to create a personalized account on the web site. In another embodiment, the web application displays information related to a user when the user signs in. In another embodiment, the web application automatically displays information related to a user if the web application is able to identify the user through a previous log in or through a unique IP address associated with the user. The information displayed may include a personalized welcome message, a personalized journal, a list of tasks related to gardening activity, and a list of shopping cart items accrued but not completed by a purchase.

In some embodiments, the user interface provides any form or type of links for both novice and experienced users to access information related to the website. The user interface may also provide clickable links, icons or graphics for access to information on any tool, services and applications available through the web site. The user interface may also provide clickable links, icons or graphical objects to log into or out of the website, or to retrieve information such as history, affiliates and job openings related to the website and/or its parent company, and privacy information related to using the web site. In addition, a link may be provided to access an introduction of the website, for example, “What is ZipHarvest” or “About Us”.

Still referring to FIG. 6A, the user interface may have any form or type of links to information, applications and tools to get a user started on using the website or to design a garden. In one embodiment, one or more links may provide access to web pages providing any form or type of applications, tools and guides related to planning, designing, implementing and maintaining a garden. These links may provide a selection of garden designs for download or purchase, the web pages including any form or type of user ratings, reviews and advertising. Other links may provide access to information, applications, tools and other links related to maintaining or improving a garden. Yet other links may provide access to information, applications and tools associated with the nutritional value, yield and recipes of any vegetable or crop harvested from a garden. The user interface may also provide one or more links providing access to service providers for planning, designing, implementing, maintaining and harvesting a garden, and may include any form or type of customer ratings, reviews and advertising related to the service providers. Further, some links may provide access to a community of people with interests in any form and type of gardening. Such access may be through an online registration to join a group of garden enthusiasts in a message board, live chat, etc, or enrolling in a newsletter. Access may also be provided to user or member web pages or web blogs, and to international, regional and local garden clubs. In addition, the user interface may provide access to a personal user account, journal, web blog, or social networking page related to garden design.

The user interface may guide a user through the steps of starting or implementing a garden, of any form and type, via the web application. In some embodiments, an overview of a set of steps are listed in sequential order for starting a garden. For example, as illustrated in FIG. 6A, the user interface may display the steps of: 1) register, 2) test your soil, 3) select your garden, and 4) get complete instructions. The steps may be displayed with embedded links, or with accompanying navigable icons and graphical objects. In one example, the first step may be the only step associated with a link on this web page, so that a user may proceed through the steps sequentially starting with this first step. In another example, each step is associated with a link to additional information about each step of the process. The displayed steps may be designed to show the simplicity of the process for inducing a user's interest, or may be designed for easy understanding by a novice in gardening. The displayed steps also may act as a guide of the user's experience and interaction via the application.

Still referring to FIG. 6A, the user interface may provide any form or type of information to convey the benefits of starting or implementing a garden. These benefits may be categorized into one or more aspects, as shown, with corresponding navigable links, icons or graphical objects. One aspect is the economic benefit of planting your own garden, including lower costs compared to buying crops and vegetables of a garden, and potentially profiting from selling or exchanging the crops and vegetables harvested from your own garden. Another aspect may be the simplicity of growing a garden. Another aspect can be health-related, wherein health benefits are promoted through growing and consuming your own garden produce. Such benefits may be derived from the nutritional value of the produce, the exercise and mental benefits from garden activities, and the avoidance of potentially toxic chemicals from commercial farming, such as certain types of pesticides. Still another aspect may be from the joy of better-tasting and fresher produce from your own garden. One other aspect is the ecological benefit of “greening” your environment and providing local produce which reduces fossil fuel consumption which typically burdens commercial produce distribution systems.

Any of the above functions or features, but not limited to the above examples, may be provided on multiple web pages of the web site to help a user navigate across the web site or access useful information and services. These features or functions, including links, may be presented in a uniform or substantially uniform manner to project a recognizable style or “feel” consistent with the image and goals of the garden design website. In addition, advertising related to gardens or gardening products, such as service providers, clubs, associations and websites, may be presented on any of the web pages in the garden design web site. Such advertising may be customized based on any form or type of attribute or preferences associated with each user.

Referring now to FIGS. 6B-6D, embodiments of user interfaces providing information associated with soil testing are depicted. In brief overview, FIG. 6B depicts an embodiment of a section main page for web pages about soil testing. FIG. 6C depicts an embodiment of a web page providing an example to soil testing. FIG. 6D depicts an embodiment of a web page providing recommendations related to with soil testing.

In further details of FIG. 6B, this user interface provides an overview of the web site section related to soil testing and provides a user access to any form and type of information related to soil testing. In one embodiment, the user interface may provide tab bars for access to categories of information on soil testing. One tab bar may be related to the process of soil testing, and may show a user how to get started, and the requirements and importance of each step of the process. Another tab bar may present an example of a soil test. The user interface may provide a navigable link, icon, or graphical object for purchasing a soil testing kit, a soil testing service or both. A soil testing kit may include tools and/or information that a user can use to perform a soil test, or may include instructions and containers for a user to collect soil samples to be delivered to a service provider. An example of a soil testing service may include having a service provider come on site to perform soil testing or collect samples for testing. The results of the soil test may be sent to the user via any form or type of delivery, including via mail, electronic mail or posted to the user's account on the web site.

Still referring to FIG. 6B, the user interface may provide a hierarchical context of the soil test sub-section relative to the home page within the web site. This may be represented by a set of links relating the garden design home page to the “Get Started” web page, and then to the current web page, as shown in FIG. 6B below the search function. A user may click on any of these links to access the corresponding web page. In another aspect, the user interface may track the step of soil testing to other steps in the process of starting a garden. One or more steps may be displayed as a sequence of icons or graphical objects as shown. In one embodiment, the web application may highlight the icon or graphical object related to the soil testing step to indicate user progress along the process. The icons or graphical objects related to a step may be activated to either present additional data corresponding to the step, or allow a user to navigate to a web page corresponding to the step. Information corresponding to an icon or graphical object may also be automatically presented responsive to an extended mouse-over longer than a predetermined period of time.

In further details of FIG. 6C, the user interface provides any form or type of results related to soil testing. In one embodiment, the web page displays a set of soil test results, responsive to a selection of a corresponding tab bar. In the embodiment shown, an example of a soil test result is provided. The soil test results may present various attributes or properties of a soil sample that underwent soil testing. The results may be formatted using tables, charts, graphs, lists, and any other presentation tools, for example, to enhance understanding of the results or aesthetics. In one embodiment, the results provides a preview of soil tests available for purchase by the user. The results may also include summary results, detailed results, or results of any granularity and combination. The form of the results presented may also be customized by the user during the purchasing process, or personalized after purchase.

The soil test results may include any form or type of attributes and properties analyzed from a soil test. The results may include measurements and calculations of the amounts of any chemical or physical component of the soil. Examples of types of soil components include organic matter, trace elements and chemical compounds. Examples of soil component include phosphorus, BiCarbonate, Potassium, Magnesium, Calcium and Nitrogen. Composition or content levels may be presented in any form or type of units such as in milligrams and parts per million by volume or weight. The results may also include attributes or properties such as the acidity and moisture level of the soil in any form and type of units. Each attribute or property may be further associated with a value indicative of the quality of the soil for supporting a garden or plant or crop of any type and form, and for any given set of conditions, including temperature, weather and season. The results may also reflect the availability of each component from the soil sample for fertilization or other purpose. In addition, the results may indicate soil conditions for weeds, pests, water retention, and any other aspect of garden maintenance. The user interface may, in addition, provide links, icons, or graphical objects for users to retrieve additional information related to any component or aspect of the results. For example, a “help” or “info” icon may be located proximate to a component for activating an information pop-up through a mouse-click or mouse-over.

In further details of FIG. 6D, this user interface provides any type and form of information for improving the quality of soil in relation to a garden design. The web application may provide recommendations to improve or optimize the fertilization or other quality of the soil. The recommendations may be based at least in part on results from a soil test. In one embodiment, the web application may provide recommendations based in part on conditions provided by the user, a service provider, or any form or type of sources such as the weather service and an agricultural authority. The web application may also provide recommendations based at least in part on the vegetable and crop mix of the user's garden design, as well as any form and type of parameters and attributes associated with the garden design. The recommendations may also include specific targets for components of the soil, indicating amounts of garden products or chemicals to add or reduce.

Further, the web application may provide any form or type of information, customized to the soil testing results, web site recommendations, or otherwise, on the types and sources of garden products or chemicals to improve the soil quality. Alternatives on the types and sources of garden products or chemicals may also be provided, including reviews of each alternative. The web page may present, via the services marketplace 109, a selection of service providers for performing the soil quality improvements, or may present a selection of retailers offering the garden products or chemicals, and including customer reviews and ratings for reference. The web page may also provide instructions to use or apply the garden products or chemicals. Moreover, the web application may provide links, icons, or graphical objects for users to retrieve additional information related to any aspect of the recommendations.

Referring now to FIG. 6E-6G, embodiments of user interfaces providing information related to selecting a garden design are depicted. In brief overview, FIG. 6E depicts an embodiment of a section main page for web pages related to selecting a garden design. FIG. 6F depicts an embodiment of a web page providing a selection of designer gardens. FIG. 6G depicts an embodiment of a web page providing details associated with a specific designer garden.

In further details of FIG. 6E, this user interface provides a user access to any form or type of information related to selecting a garden design. The user interface may provide an overview of the web site section related to selecting a garden design. The web interface may also provide tab bars to different sections of information related to selecting a garden design. In one embodiment, the web page presents an introductory description of a garden design, and may include considerations and steps to selecting a garden design. The considerations may include space limitations for the garden, aesthetics, soil type, climate, season, indoor or outdoor conditions, plant and crop mix, nutritional value, yield, ease and cost of establishing, maintaining and harvesting the garden, and other aspects. The web application may provide navigable links, icons and graphical objects to various types of gardens, providing pictures and information from the website, service providers or garden owners.

In further details of FIG. 6F, this user interface provides a selection of any type and form of designer gardens provided through the web site. The user interface, provided by Garden Kits eCommerce 108 in one embodiment, may list designer gardens by any form and type of theme. For example, a theme may be directed to nutritional value, culinary preferences, plant or crop categories, aesthetics, ease of maintenance, levels of expertise, a celebrity gardener or chef, or seasons. Each designer garden may be associated with a price, reflecting a quote from a service provider or the costs related to setting up the garden. Each designer garden may have a name associated with a theme or any attribute of the garden. The name may comprise a number, string, alphanumeric character, symbols, or any combination thereof. The name may comprise and type and form of identifier for a garden theme. In some embodiments, the name or identifier of the garden design is descriptive of a style, type or form of garden. In other embodiments, the name or identifier may include or be associated with any type and form of icon, emoticon, graphic or pictorial. Additionally, a designer garden may specify an area requirement, or any form and type of condition required or suitable for the garden. Further, a level of ease may be specified for each designer garden, and may reflect the ease or difficulty of establishing, planning, maintaining, and/or harvesting the garden, as well as the time requirements. The web page can also provide the expected yield of the designer garden, which may be conditioned by any number of factor such as soil, garden size, season, weather and fertilizer conditions. The user interface may, in addition, provide links, icons, or graphical objects for users to retrieve additional information related to any designer garden or aspect of the information presented.

In further details of FIG. 6G, the user interface provide any form and type of information related to a selected designer garden. This web page may be displayed when a user selects a designer garden from the selection of designer gardens described above in connection with FIG. 6F. In addition to the garden-specific information, this web page may include information distinguishing it from other designer gardens, or highlight information specific to the theme or any particular attribute(s) associated with this designer garden. For example, for a salad-themed designer garden, the information may include the nutritional value and taste of the plants and crops from the garden. The web page may list the plants and crops of the designer garden, and provide corresponding information such as area allocated for each type of plant or crop, ease of planting and harvesting, yield, nutritional value, market value and serving portions. The user interface may, in addition, provide links, icons, or graphical objects for users to retrieve additional information related to any crop or plant in the list.

The web interface may display any form and type of layout of the designer garden. The layout may be color-coded or patterned to indicate plant or crop mix and location, and may be presented in any orientation, in two dimensions or three dimensions. The layout may also include garden-related features such as buffer zones, fencing, trellises and irrigation channels. In addition, the user interface may provide a link, icon, or graphical object for a user to initiate purchase of the designer garden. For example, activating the link will place the designer garden into an online shopping cart.

Referring now to FIG. 6H, an embodiment of an user interface that provides any form or type of information associated with a variety of garden crops and plants. A user may, for example, access this web page via the user interface of FIG. 6G by clicking on a link associated with a crop or plant. A user may also access this page via the “In the Garden” section of the web site, as indicated by the hierarchical indicators below the search function. This user interface may provide a number of tab bars representing sections of information relating to each crop or plant. Instead of tab bars, navigable links, icons, and graphical objects may be provided in place. Each tab bar, when selected, may present sections of information, including general, nutritional, growing, recipe information and information about gardens featuring the specific plant or crop.

In each section, the information for each plant or crop can be of any level of detail and retrieved from any form or type of sources. Examples of sources includes the gardening database 112, the service provider database 113 and any online database. The general information can include the genus and visual attributes of the crop or plant or the related fruit and leaves. Nutritional information may include vitamins and minerals provided per serving portion, health benefits and medicinal value. Growing information may include growing difficulty, special requirements, maturation time, shade tolerance, yield range and value. Recipe information may include any preparation steps and tips associated with any form and type of recipes including recipes by celebrity nutritionists and chefs. Garden information may include pictures and information of designer gardens featured by the web site or gardens provided by users and service providers, examples of which are described above in connection with FIGS. 6F-6G.

Referring now to FIG. 6I-6M, embodiments of user interfaces providing information related to using and maintaining a garden workbook are depicted. In brief overview, FIG. 6I depicts an embodiment of a section page for web pages related to using and maintaining a garden workbook. FIG. 6J depicts an embodiment of a web page providing sample information associated with garden preparation. FIG. 6K depicts an embodiment of a web page providing sample information associated with planting schedule. FIG. 6L depicts an embodiment of a web page providing sample information associated with planting instructions. FIG. 6M depicts an embodiment of a web page providing sample information associated with harvesting a garden.

In further details of FIG. 6I, the user interface provides any form and type of information associated with a garden workbook. A garden workbook includes a guide that explains each step of the process of growing a user's garden, from the planning stage to the harvesting stage. The garden workbook may also include a personalized journal to track the user's experience. As a journal, the user may use the information at any time during the process to track a garden or a crop's progress against that predicted by the website. The user may also make the journal available online as a web blog or other online resource to share the user's experiences, including any form or type of gardening tips and techniques, and reviews of a garden, crop, or service provider. In one embodiment, the journal may be available only through the web site, such as to registered users of the web site. In another embodiment, the journal may be featured in a newsletter published by the web site and sent electronically or otherwise to anyone who has signed up for the newsletter.

The user interface provides an overview of the section of the web site for using and maintaining the garden workbook. The web application may provide tab bars or links to different sections of information related to using and maintaining a garden workbook. In one embodiment, the web page presents an introductory description of a garden workbook, including reasons for using and maintaining a garden workbook. The web page may include user testimony about their experiences with their garden workbook. The web page may also provide sample workbooks for reference. Moreover, the web application may provide navigable links, icons and graphical objects to one or more workbooks maintained by other users, such as other workbooks of the garden design selected by the user.

Referring to FIG. 6J, the user interface provides a sample workbook. The user interface may provide tab bars or links to different sections of the workbook. Example sections include the user's garden, garden preparation, planting schedule, planting instructions, and harvesting. The user's garden section may include information about the designer garden selected by the user, or a garden customized by the user. One embodiment of the information may be presented in a manner substantially similar to that described above in connection with FIG. 6G. A real workbook associated with a user may be substantially similar to the sample workbook. In addition, the sample workbook may be customized to reflect the designer garden currently selected by the user viewing the sample workbook.

The user interface may provide any form or type of information related to garden preparation, as either a sample workbook (as shown) or a real workbook. When the user selects the garden preparation section of the user interface, information related to planning and establishing a garden is presented. Such information may advise the user on performing a soil test, treating the soil, choosing a location, plowing the garden, and waiting for the right season or weather conditions. In one embodiment, the information provided is only a guideline. In another embodiment, other sources of information, such as from local garden associations and service providers, supplements the information provided by the web site.

In further details of FIG. 6K, the user interface may provide any type and form of information associated with a planting schedule, as either a sample workbook (as shown) or a real workbook. When the user selects the planting schedule section of the user interface, information related to scheduling the steps of the planting process is presented. In one embodiment, other sources of information, such as from local garden associations, service providers and local weather service, supplements the planting schedule. The user interface may provide links to other sources of information, or may enable the user to update relevant information to update the planting schedule. Relevant information may include rainfall, temperature, frost, hours of daylight, etc. The web application may provide the planting schedule for each type of plant or crops featured in the garden. Planting schedule information may include dates, time periods, and milestones related to temperature, frost, solstices, rainfall, etc.

In further details of FIG. 6L, the user interface may provide any form or type of information associated with a planting instruction, as either a sample workbook (as shown) or a real workbook. When the user selects the planting instructions section of the user interface, information related to the steps of the planting process is presented. Other sources of information, such as from local garden associations and service providers, may supplement the information provided by the web site. Planting instructions may include steps on preparing seeds, shoots, cuttings, buds and spores (hereafter generally referred to as “seeds”) of plants and crops, digging to the depth to bury the seeds, pre-growing certain plants and crops, providing protective cover for seedlings, etc. The user interface may provide planting instructions specific to each type of plant or crop.

Referring now to FIG. 6M, the user interface may provide any form or type of information associated with harvesting any type of plant or crop, as either a sample workbook (as shown) or a real workbook. When the user selects the harvesting instructions section of the user interface, information related to the steps of the harvesting is presented. Other sources of information, such as from local garden associations and service providers, may supplement the information provided by the web site. The user interface may provide harvesting instructions specific to each type of plant or crop featured in the garden. Harvesting instructions may include the step of removing a fruit, vegetable, leave, root, stem, fungus, flower, bud, shoot, tuber or other garden produce (hereafter generally referred to as “produce”) from a garden, plant, crop, soil, trellis, or other garden entity, with or without a tool. The instructions may also include produce selection and other techniques for harvesting a produce.

Referring now to FIGS. 6N, the user interface provides a garden selection and creation interface. The user interface, provided by the intelligent garden designer 107, may include a variety of garden designs, layouts or templates (hereafter generally referred to as “layout(s)”) to select from. Each layout may be associated with a plant or crop mix. Further, each layout may be associated with a name or theme, which may be based in part on some attribute of the layout, for example the shape of the garden or the predominance of a certain type or group of plant or crop. Information such as the size and dimension of each layout may be provided. The user interface may also display any form and type of layout, including rectangular and non-rectangular layouts. The layout may be color-coded or patterned to indicate plant or crop mix and location, and may be presented in any orientation, in two dimensions or three dimensions. The layout may also include garden-related features such as buffer zones, fencing, trellises and irrigation channels. The user interface may provide a link, icon, or graphical object for a user retrieve additional information related to any layout in the selection. In addition, the user interface may allow the user to resize or re-orientate any of the layouts for scrutiny. In one embodiment, the user can select a garden layout by clicking on a button associated with the garden layout.

Referring now to FIG. 6O, the user interface provides a garden layout editor. The layout editor may be accessed by selecting one of the designer garden layouts, or a “new” layout, as described above in connection with FIG. 6N. Selecting a “new” layout provides the user the opportunity to create a layout from scratch. Selecting any of the designer garden layout allows the user to customize the garden if the user chooses to. The layout editor may display any form or type of layout, including rectangular and non-rectangular layouts. The displayed layout may be color-coded or patterned to indicate plant or crop mix and location, and may be presented in any orientation, in two dimensions or three dimensions. The color and pattern scheme may be modified by the user for functional or aesthetic reasons. In addition, the user interface can allow the user to resize or re-orientate the layout for scrutiny. The displayed layout may also include editable garden-related features such as buffer zones, fencing, trellises and irrigation channels. Regions on the layout reflecting conditions such as shade and different soil mix may be specified. The user interface may display a variety of garden crops to select from. The user may add, move or delete the seeds of plants or crops to the layout. Statistics about the plants and crops may be tracked by the web application as they are added or removed. Statistics may include area occupied and plant or crop count and density. A database, such as the gardening database 112 or the service provider database 113, may provide rules about crop or plant spacing, shade and soil requirements, acceptable plant mix, etc. or any constrains thereof The editor may highlight regions for which any of the rules are violated or otherwise may prevent the user from making a certain plant placement or arrangement. The user interface may warn the user about the violation or constraint, such as via a pop-up with an explanation. The editor may also disallow a user to make an edit if the edit will result in a violation or otherwise make an undesirable action.

Referring now to FIG. 6P, the user interface provides any form or type of information related to food preparation and the nutritional value of plants and crops harvested. The web page may present an introduction or overview of food preparation using plants and crops harvested from a garden. The user interface may also provide navigable links, icons, or graphical objects for a user access various sections of information. One section may include any form or type of information related to recipes. This may include any preparation steps and tips associated with any recipe including formal dining recipes, “quick and easy” recipes, healthy recipes, and recipes by celebrity nutritionists and chefs. Another section may include any form or type of information related to best practices in the kitchen. This may include tips and recommendations such as for washing, storing, and preparing produce, conserving the nutritional value of produce and avoiding waste. Still another section may include a listing or glossary of produce and kitchen items, linked to additional information corresponding to the produce or item.

Yet another section may include any form or type of information associated with at least one featured chef. This may include biographical information, interviews, tips and links to their recipes. Another section may include any form or type of information related to a gardening community. A gardening community may be local, regional, national, international, or online, and include persons, clubs, associations, service providers and websites related to any form or type of plant or crop gardening. The section may include links to other web sites, web blogs, garden workbook, social networking sites and service providers. The section may also provide access to online discussion boards, gardening news, and the ability to sign up for gardening newsletters. Still another section may include any form or type of information associated with nutrition. This may include information such as the nutritional value of any form or type of plants and crops, recommended servings, combinations with non-garden produce and various diets.

Referring now to FIG. 6Q, the user interface provides any form or type of information related to garden maintenance. The web page may present an introduction or overview of garden maintenance. The user interface may also provide navigable links, icons, or graphical objects for a user access various sections of information related to garden maintenance. One section may include any form or type of information related to garden tools. This may include information about do-it-yourself (DIY) toolkits, garden extenders, retailers, online applications and tools. Another section may include any form or type of information related to best practices in the garden. This may include information such as tips and recommendations for composting, addressing weeds and pests, fertilization, clearing a piece of land, irrigation, watering and drainage. Still another section may include a list or glossary of gardening tools, materials and other essentials, with corresponding links to additional information on each item.

Another section may include any form or type of information related to one or more featured gardener. A featured gardener may be a celebrity, a professional gardener or may be from a gardening community, or a user of the web site. This section can include biographical information, interviews, tips and garden workbooks related to each featured gardener. Still another section may include any form or type of information related to a gardening community as described above in connection with FIG. 6P. Yet another section may include any form or type of information related to “frequently asked questions”. This section may include gardening tips, techniques, advice from other gardeners, including professional and celebrity gardeners.

In further details of FIG. 6R, the user interface provides a selection of designer gardens and information associated with each designer garden. This user interface may be provided in response to a search performed by a user, based on one or more search criteria. Search criteria may include cost, ease of gardening, specific crop or plants, size of the garden, customer ratings, season, and theme. The web page may show a subset of the search results, with additional links to the rest of the results. The web page may also provide additional criteria to be selected for narrowing or changing the search, such as using price ranges, and specifying manufacturers or service providers. Additional functions may be provided to display all results in a single web page and to sort the results using various criteria. The user may select one of the garden designs to move to an online shopping cart, or may initiate a purchase from the user interface. The user interface may also indicate the payment method accepted.

The user interface may provide any form or type of selections to search different products, and categories of information. In one embodiment, the web page includes links to other products and services offered by the web site or offered through the web site by retailers or service providers. These links can be for categories of products or specific products, and may specify these as “best-sellers” or “favorites” as statistically determined by the web application. For example, favorite categories may include designer gardens, organic fertilizers, soil testing services and toolkits, and garden tools. Favorite products may include a specific design garden, such as the Zesty Salad Garden. In addition, the web page provides selections to other sections of the web site. The sections may include designer gardens, featured books related to gardening, garden tools, garden goods, season extenders, seed lists and soil testing. Each of these selections may bring up a menu with further selections for access to subsections of the website.

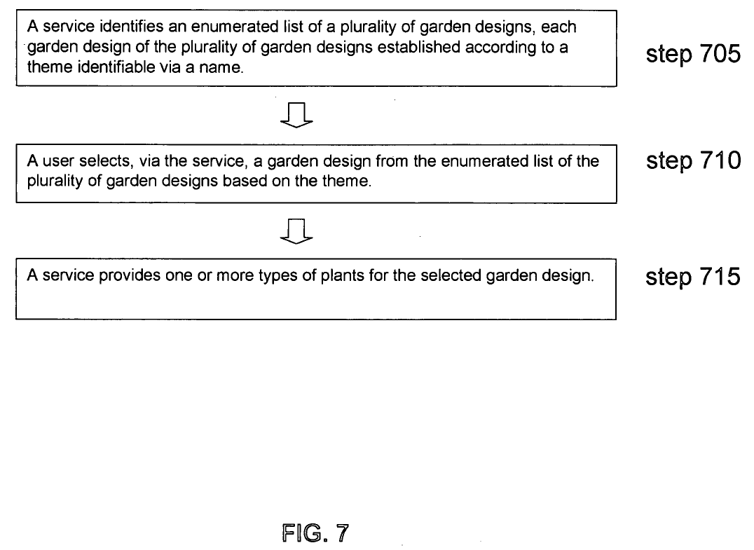

Referring now to FIG. 7, an embodiment of steps of a method for selecting a garden design from a plurality of garden designs based on a theme is depicted. In brief overview, at step 705, a service identifies a list of garden designs, based on a theme. At step 710, a user selects, via the service, a garden design from the list. At step 715, the service provides one or more types of plant or crop for the selected garden design.

In further details of step 705, the service identifies a list of any form or type of garden design based on any form or type of theme. In some embodiments, a theme may be related to seasons, celebrities, diet, health, plant or crop types or families, and aesthetics or styles. In other embodiments, a theme may be developed over a set of any form or type of criteria. A list of garden designs may be provided by the user interface illustrated in FIG. 6F. Each of the plurality of garden designs may be identified by a name or identifier. The service may enumerate, arrange or organize a list of garden designs in any manner or format. The service may also determine and display the yield size or the market value for each garden design. The yield size may be calculated from any form or type of conditions specified for the garden design, including areas allocated for each type of plant or crop, the number of plants or crops, the rainfall, the soil conditions and amount of available sunlight. The market value may be derived from databases which may include seasonal prices for any form or type of plant or crop, and may be determined from the yield size. These databases may be generated using data from wholesale providers of produce or retailers, and may reflected regional or local pricing as well as other factors such as bad weather conditions. The yield size or market value may also be extrapolated, adjusted or scaled from existing database values against any conditions.

The service may identify any form or type of information related to implementing any garden design. In one embodiment, the service determines a level of ease or difficulty for implementing each garden design. The service may determine the levels based on the time and effort required or expected for a garden design, including planning, establishing, maintaining and harvesting the garden design. The service may also determine the levels based factors such as cost, soil conditions, and seasonal characteristics, which may affect the viability of the garden design. The service may further associate each level with an expertise level, such as novice, intermediate, expert, or “green thumb”. These levels may also be determined from feedback from service providers, gardeners, farmers and customers, such as from ratings and reviews related to garden designs, plants and crops. The service may also identify the area required for any form or type of garden design. The size of a garden plot may be determined from the number and size of plants and crops in the garden as well as features such as buffer zones, irrigation channels, fences and trellises.

The user may specify any form or type of criteria to search for garden designs. The user may have specific needs, interests or constraints, reflected in a set of criteria to limit the scope of available designer gardens. Responsive to the search based on the criteria, the service may return results including any number of gardens designs meeting the criteria. Examples of the criteria, search and results are described above in connection with FIG. 6R. The user may apply a set of criteria to narrow down the number of designer gardens based on a theme. The user may also identify a theme as a criteria to narrow down a designer garden search.

In further details of step 710, the user may select a garden design from a list of garden designs. In response to identifying a theme, the service may return a set of designer gardens related to the theme, with and without further criteria to narrow down the available selection of designer gardens. If the service provides at least one designer garden for selection, the user may further narrow down the selection via a sub-theme or additional criteria. The user may select, via the service, any of the available selection of designer gardens, as described above in connection with FIG. 6F, 6N or 6R. The criteria for selection of the garden design may be based on one or more of yield size, nutritional value, market value, size of area, and level of ease of implementing. The user may browse a plurality of garden designs before selecting one of the garden designs. The user may choose the garden design by highlighting and/or clicking a garden design via any type and form of user interaction and/or user interface element. The user may select the garden design by adding the selected garden design to a shopping cart. The user may select the garden design and add the garden design to a profile of the user via the service.

In further details of step 715, the service provides information on the type and number of plants for the selected garden design. Upon selection of a garden design, the service may present the user a user interface described above in connection with FIG. 6G or 6O. In one embodiment, one or more types of plants or crops are listed. In another embodiment, a table describes the number of plants or crops provided. The plants or crops may also be displayed on a garden layout provided by the service, and may be represented in any form or type, such as dots, plant-shaped graphical objects, icons or symbols. Regions on a garden layout may be color-coded or patterned to represent the different types of plant or crop.

Any form or type of information related to each of the plant or crops may be provided by the service and displayed on the user interface as described above in connection with FIG. 6G or 6O. The service may identify each of the one or more types of plant or crop by a name or other identifier. The service may also determine and display the yield size or the market value for each type of plant or crop. The yield size may be calculated from any conditions specified for the garden design, including area allocated for each type of plant or crop, the number of plants or crops, rainfall, soil conditions and amount of available sunlight. The market value may be derived from databases which may include seasonal prices for any type of plant or crop, and may be determined from the yield size. These databases may be generated using data from wholesale providers of produce or retailers, and may reflect regional or local pricing as well as other factors such as bad weather conditions. The yield size or market value may also be extrapolated, adjusted or scaled from existing database values against any condition. The service may also identify the number of servings for each type of plant or crop, and the number of servings may be determined from the expected yield size.

An embodiment of the steps for interactively designing a garden comprising one or more plants includes receiving, by a service, an identification of a size of a garden. In one embodiment, the user identifies the size of the garden from a predetermined list of garden sizes. The size of a garden may also be identified based on selection of a garden design from a group of garden designs. The service may provide a graphical representation of a layout of the garden corresponding to the identified size. In addition, the service may receive an identification of a shape or orientation of the garden based on a selected designer garden. The service may then provide a graphical representation of the layout corresponding to the identified shape or orientation. The graphical representation may be provided via a garden layout editor provided by the intelligent garden designer 107.

The user may select one or more types of plants or crops from a list provided by the service. Based on the selection, the service may then arrange a graphical representation of each plant and crop onto the layout for the garden. In one embodiment, the service receives a request to determine an arrangement for graphical representations of the selected plants or crops based on factors such as space of the garden, yield of the garden or market value of the garden. In another embodiment, the service may automatically make an arrangement of the graphical representations of the selected plants or crops on the layout. The service may also determine the arrangement based on the identified number and types of plants or crops. Each plant or crop may be associated with an footprint, established by factors such as the size of the mature plant or crop, and any recommended or required spacing between any two plants or crops. The service may also display a graphical arrangement of the plants and crops on the layout based on the established footprints.

The arrangement of the plants and crops may be determined so as to provide an optimized yield or market value based on the types of plants and crops in the garden. Further, the arrangement of the plants and crops may be determined based on factors such as the identified size, shape and orientation of the garden. The service may limit an action of the user in arranging a plant if this violates the compatibility between a first plant type and a second plant type. In addition, the service may indicate, in any form or type, an action of the user taken in arranging a plant based on the compatibility between a first plant type and a second plant type. An example of an indication may be a pop-up warning accompanying an incompatible arrangement. Other embodiments of the steps are described above in connection with FIG. 6O.

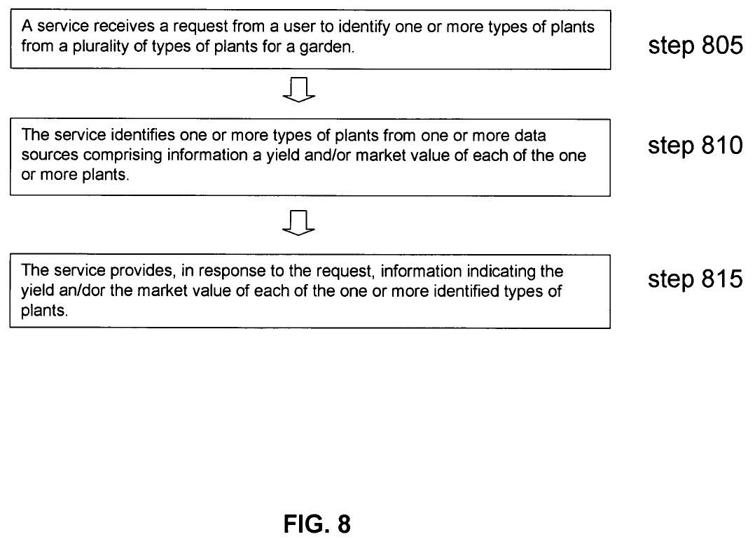

Referring now to FIG. 8, an embodiment of steps of a method for identifying one or more plants based on yield or market value information is depicted. In brief overview, at step 805, a service receives a request to identify one or more types of plant or crop for a garden. At step 810, the service identifies one or more types of plant or crop from data sources which include nutritional, yield or market value information of the one or more types of plant or crop. At step 815, the service provides nutritional value, yield or market value information of the one or more types of plant or crop responsive to the request.

In further details of step 805, the service receives a request to identify one or more types of plant or crop for a garden. The request may be based on any type of user selected criteria, including market value, nutritional value, yield, aesthetics, ease of planting, and compatibility with the season. In one embodiment, the request is activated by the selection of a link, icon or graphical object tied to one or more criteria. In another embodiment, the request is activated by a search function provided by the service, the search function including a number of user selectable criteria.

In further details of step 810, the service identifies one or more types of plant or crop from one or more data sources. Based on the request and criteria from the user, the service may identify one or more types of plant or crop from one or more data sources. The one or more data sources may have nutritional, yield or market value information for each type of plant or crop. The service may identify the yield of each type of plants or crop as an amount of output in weight provided by each of the one or more plant or crop. The service may also identify the yield of each type of plant or crop as an amount of output in servings provided by each of the one or more type of plant or crop. In addition, the service may determine the market value of each type of plant or crop by expressing the yield of each type of plant or crops into dollar value. The service may also provide a predefined selection of one or more type of plant or crop based on a predetermined set of criteria based on market value, nutritional value or yield.

In further details of step 815, the service provides nutritional value, yield or market value information for the one or more types of plant or crop responsive to the request. The service may provide information on the nutritional characteristic of each type of plant or crop, such as information about protein, vitamins, minerals, fiber, calories and recommended daily allowance. The service may also provide geographically based information about the types of plant or crop, such as availability and suitability for certain seasons, market value, and fertilizer requirements. The service may also provide information based on the soil composition requirements for each type of plant and crop. In addition, the service may store information received from the user about each type of plant, crop or garden, such as yield realization, installation, maintenance, aesthetics, taste, and nutritional characteristic. The service may, for example, store this information in the user database 111 and the gardening database 112.

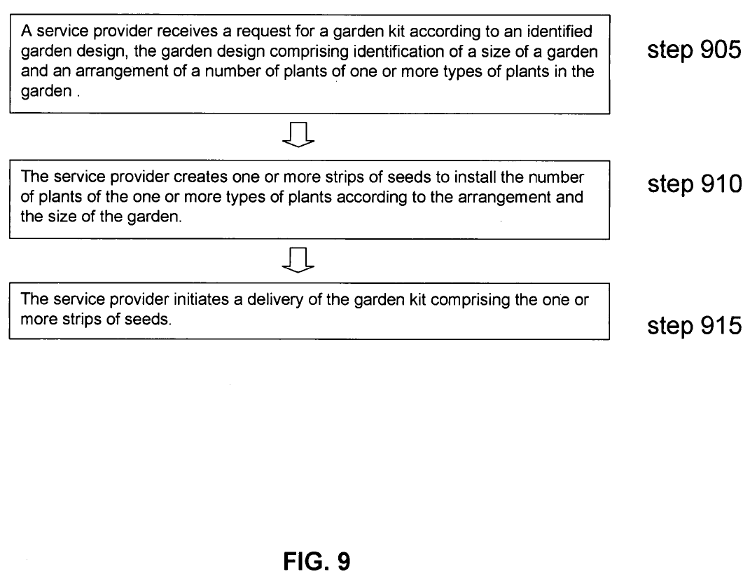

Referring now to FIG. 9, an embodiment of steps of a method for providing a garden kit 500 comprising seeds and materials to implement an identified garden design is depicted. In brief overview, at step 905, a service provider receives a request for a garden kit 500 according to an identified garden design, which includes identification of a garden size and plant arrangement. At step 910, the service provider creates strips of seed for installing plants according to the garden size and plant arrangement. At step 915, the service provider initiates a delivery of the garden kit 500 including the strips of seeds.

In further details of step 905, the service provider receives a request for any type and form of a garden kit 500. In some embodiments, the service is the services marketplace 109. The service provider may receive a request from a service to create a garden kit 500 for a user. The service provider may also receive a request from a service to deliver a garden kit 500 to a user. The service provide may receive a request for a garden design based on an identified theme. A request may be received for a garden kit 500 corresponding to an identified garden design with a defined garden size and plant or crop arrangement. The service provider may receive the request for a garden kit 500 corresponding to a garden design selected from a plurality of predetermined garden designs. The request may be generated in response to a user purchasing a designer garden or a user-designed garden through the web interface. The request may also be generated in response to a user purchasing a garden kit 500 from a selection of available garden kits provided through the web interface. In another embodiment, the garden kit 500, or any component thereof, is designed, specified and/or assembled by a user via the web interface.

In further details of step 910, the service provider creates any form or type of garden kit. The service provider may create a garden kit 500 according to received specifications which may include a garden size and plant arrangement. The service provider may also create a garden kit 500 according to specifications corresponding to a designer garden or user-designed garden described above in connection with FIG. 5. In addition, the service provider may create strips of seed included in a garden kit 500 for installing plants. In one embodiment, the seeds are embedded in a fertilized, biodegradable mat for example. In another embodiments, the seeds are installed via a strip of seeds. Multiple strips of seeds may be created for different plants and crops. The garden kit 500 may be assembled to include one or more gardening tool or equipment 504. The garden kit 500 may also be assembled to include any form or type of gardening guide, service provider information 505, installation instructions 502 and maintenance instructions 503, such as in booklet form or recorded on any media. The service provider may also create a garden kit 500 including a graphical representation of the garden design, such as a poster or visual aid for installing the garden, seeds or crops.

In further details of step 915, the service provider initiates any form or type of delivery of the garden kit 500 to a user of the service. In one embodiment, the service provider mails the garden kit 500 through the postal service or a courier service. In another embodiment, the garden kit 500 is delivered by the service provider, for example, by a delivery van from a local office of the service provider. In still another embodiment, the garden kit 500 is available for pick-up at any retailer outlet or location affiliated with the service provider. Part of the garden kit 500 may also be delivered electronically, such as the maintenance instructions 502, while the rest is delivered via any of the methods described above.

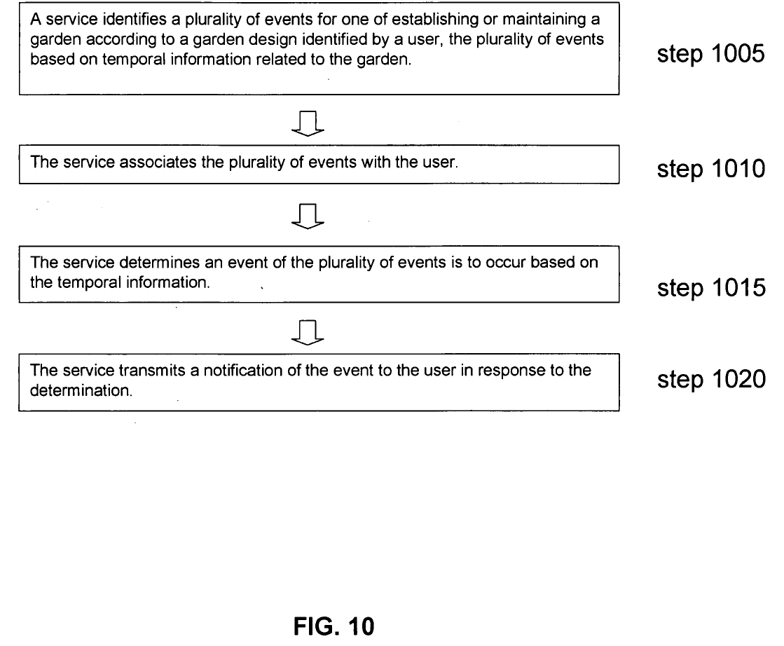

Referring now to FIG. 10, an embodiment of steps of a method for notifying a user of a service of one or more events related to maintenance of a garden according to a garden design identified by the user is depicted. In brief overview, at step 1005, a service identifies events for establishing or maintaining a garden design identified by a user. At step 1010, the service associates the plurality of events with the user. At step 1015, the service determines the occurrence of an event based on garden-related temporal information. At step 1020, the service transmits a notification of the event to the user responsive to the determination.

In further details of step 1005, the service identifies any form or type of event for establishing or maintaining a garden design identified by a user. The service may identify an event based on the one or more types of plants or crops in the garden. The service may identify a set of events corresponding to the size, irrigation needs, and other elements of the garden. In addition, the service may identify events to be scheduled over a period of time based on a user provided date of installation of a garden. The events may include any type of starting, planting, installing, maintenance, grooming, harvesting, or any other type and form of task or activity related to a garden.

In further details of step 1010, the service associates a set of events with a user. The service may associate a set of events to a user account, created upon completion of a user registration process through the web interface. The events may also be associated with two or more persons tending to a shared garden. Further, the events may be associated with a service provider tending to a garden purchased by the user. Moreover, the service may associate the events with a user via the user's garden workbook. In some embodiments, the events determined for a selected or identified garden design are associated with the user or user account. In other embodiments, a template of events are associated with each of the plurality of garden designs. In another embodiment, events related to one or more service providers, such as via the service marketplace, are associated with the user. In some embodiments, the list of tasks or activities for implementing the garden are each events to be or associated with the user.

In further details of step 1015, the service determines an event based on any form or type of temporal information related to the garden or any portion thereof. For example, types of plants may require different levels of care via periodic tasks: tomatoes may be watered or fertilized more frequently than squash, while herbs must be weeded regularly. The determination of an event be, for example, thirty days from the user's installation of a garden. An event may also be determined relative to a status reported or noted by the user, such as seven days after the first sprouting from seeds, appearance of weed, or a first frost condition. An event may also be determined based on a season and/or a geographic location of the garden, for example, for performance of certain tasks to optimize the yield of the garden. In some embodiments, an event template for a garden design may be customized or updated based on temporal information received from the user, such as date of installing the garden.

In further details of step 1020, the service transmits any form or type of notification of the event to the user responsive to the determination. In one embodiment, the service emails the user a notification. In another embodiment, the notification may be sent using the postal service or a courier. In still another embodiment, the notification can be posted to a web site accessible by the user, such as through the web interface on the user's workbook. The service may also transmit a notification via an electronic calendar, such as using the MICROSOFT OUTLOOK calendar. The notification transmitted via the electronic calendar may be in the form of an appointment, a meeting or a task, and displayed in a pop-up window for example, at a scheduled time. The notification may include any type and form of information relating to the event triggering the notification and/or other events associated with the garden. The notification may include any type and form of interface to receive acknowledgement, status and any other information from the user. In some embodiments, the notification may include one or more links to the user's account, the garden design, information on the plants of the garden, and/or instructions related to implementation and/or maintenance of the garden.

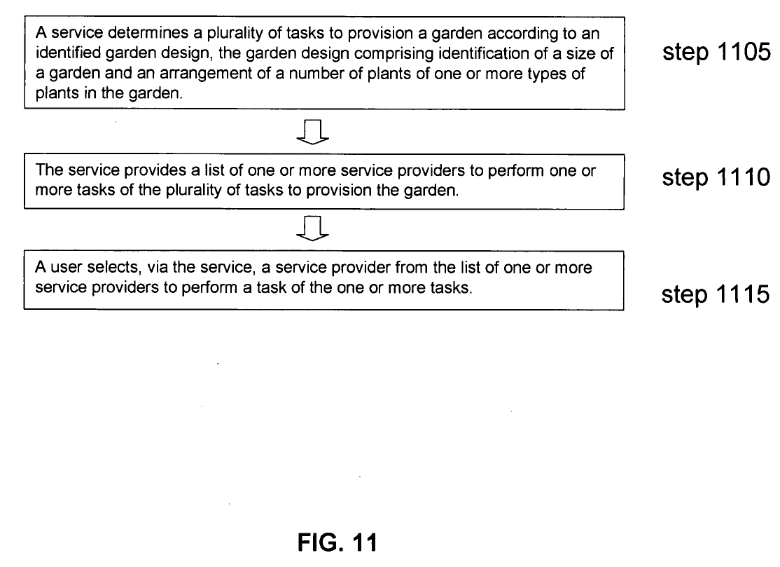

Referring now to FIG. 11, an embodiment of steps of a method for selecting one or more service providers to implement a specified garden design is depicted. In brief overview, at step 1105, a service determines tasks to provision a garden according to an identified garden design. At step 1110, the service provides a list of service providers to perform tasks to provision the garden. At step 1115, a user selects, via the service, a service provider from the list of service providers to perform a task.

In further details of step 1105, the service determines any form or type of tasks to provision a garden according to an identified garden design. The garden design can include an identification of a garden size, a plant arrangement or any type of characteristic or specification for identifying one or more tasks. For example, the identification of a task may be based on the garden size, the number and type of plants and crops in the garden, and the layout arrangement of plants and crops in the garden. The service may identify one or more tasks for the installation of the identified garden design. For example, identified garden installation tasks may include clearing a plot of land of the desired size and soil testing. The service may also identify one or more tasks for maintenance of the identified garden design. For example, identified garden maintenance tasks may include periodic fertilization, weeding, and pest control. The service may also identify one or more tasks for harvesting plants and crops of the identified garden design. For example, identified tasks for harvesting may include checking the produce for maturity, acquiring the essential harvesting tools, and removing fertilizer and insecticide from the produce. In some embodiments, the service may use any type and form of template of tasks for a garden, and may have such templates for each of the garden design.

In further details of step 1110, the service provides a list of any form or type of service provider to perform any of the tasks to provision the garden. The service may provide one or more lists or categories of service provides. For example, a list or category may be for retailers of gardening tools, seeds and material. Another list or category may include service providers that provide garden kits based on a specific garden design. Still another list or category may include service providers that offer installation services, soil testing services, and routine maintenance or harvesting services. Still another list or category may include service providers that provide one or more types of services described above.

The service may provide any form or type of feature that may help a user find a service provider. The service may provide a search function which allow a user to specify one or more criteria for identifying a service provider. For example, the service may match a service area of service providers to the location of the user. The service may match a service provider based on time of mailing a purchase to the user or traveling distance between the user and service provider locations. Moreover, the service may provide pricing information of each service provider for each of the identified tasks. In one embodiment, the service may provide a planning tool for selecting a number of service providers to complete a number of tasks and comparing the accumulated pricing to a budget. In another embodiment, the service may rank a group of service providers offering the same services by price. The service may also provide comments or ratings, from customers of each service provider, to the user. In one embodiment, the service may rank a group of service providers by the average rating each of these received. In addition, the service may rank or re-arrange a group of service providers listed by any other type of attribute such as popularity, size of the service provider's business and the breadth of services offered.

In further details of step 1115, a user selects, via the service, a service provider from the list of service providers. The user may narrow down the list of service providers by using any number of criteria or preferences, such as by using the search function provided by the web application. From the available list of service providers, the user selects a service provider, such as by clicking on a link, icon or graphical object representing the service provider, or the service or product it offers. The service may place the selection into the user's online shopping cart, and the user may choose to complete the purchase at any time while the selection remains in the shopping cart. The service may initiate an electronic transaction with the selected service provider based on user instructions. Payment and delivery methods may be specified by the user. Once a purchase is finalized with a service provider, the service can communicate any form and type of information related to the user or the user's garden design to the service provider. Examples of information communicated may include an identification of the garden design selected by the user, and specific instructions or requests, including payment and delivery method. The service can also communicate any form or type of information related to the service provider to the user, such as via electronic mail or via the web site, such as estimated deliver time and contact information. The user may also communication any form or type of information related to the service provider to the service, such as rating and comments on the service.

Having described certain embodiments of methods and systems for online garden design, it will now become apparent to one of skill in the art that other embodiments incorporating the concepts of the disclosure may be used. Therefore, the disclosure should not be limited to certain embodiments, but rather should be limited only by the spirit and scope of the following claims.

It is claimed:

1. A method for selecting a garden design from a plurality of garden designs based on a theme, the method comprising the steps of:
(a) identifying, by a service, an enumerated list of a plurality of garden designs, each garden design of the plurality of garden designs established according to a theme identifiable via a name;
(b) selecting, by the user via the service, a garden design from the enumerated list of the plurality of garden designs based on the theme; and
(c) providing, by the service, one or more types of plants for the selected garden design.

1. The method of claim 1, wherein step (a) further comprises identifying, by the service, one of a yield size or a market value for each garden design.

2. The method of claim 1, wherein step (a) further comprises identifying, by the service, a level of ease for implementing each garden design.

3. The method of claim 1, wherein step (a) further comprises identifying, by the service, a size of an area for implementing each garden design.

4. The method of claim 1, wherein step (a) further comprises identifying, by the service, the enumerated list of the plurality of gardens based on user provided criteria.

5. The method of claim 1, wherein step (b) further comprises selecting, by the user, the garden design based on one or more of the following: yield size, market value, size of area, and level of ease of implementing.

6. The method of claim 1, wherein step (c) further comprises identifying, by the service, each of the one or more types of plants by name for the selected garden design.

7. The method of claim 1, wherein step (c) further comprises identifying, by the service, one of a yield or a market value for each of the one or more types of plants of the selected garden design.

8. The method of claim 1, wherein step (c) further comprises identifying, by the service, a number of servings for each of the one or more types of plants of the selected garden design.

9. A method for interactively designing a garden comprising one or more plants from a plurality of plants, the method comprising the steps of:
(a) receiving, by a service, identification of a size of a garden, the service providing a graphical representation of a layout of the garden corresponding to the identified size.
(b) arranging, via the service, onto the layout for the garden a graphical representation of a number of plants for each of the one or more types of plants, the one or more types of plants selected by a user from a list of a plurality of types of plants provided by the service; and
(c) displaying, by the service, the graphical arrangement of the number of plants for each of the one or more types of plants onto the layout based on an established footprint that each of the number of plants occupies in relation to the identified size, the established footprint corresponding to the one or more types of plants.

10. The method of claim 1, wherein step (a) further comprises identifying, by the user, the size of the garden from a predetermined list of garden sizes.

11. The method of claim 1, wherein step (a) further comprises identifying the size of the garden based on selection of a garden design from a plurality of garden designs.

12. The method of claim 1, wherein step (a) further comprises receiving, by the service, identification of one of a shape or orientation of the garden and providing the graphical representation of the layout to correspond to the identified shape or orientation.

13. The method of claim 1, wherein step (b) further comprises automatically arranging, by the service, an arrangement of the number of plants for each of the one or more types of plants in the layout for the garden.

14. The method of claim 1, wherein step (b) further comprises determining, via the service, an arrangement of the number of plants in the layout of the garden based on identification of the number of plants for each of the one or more types of plants.

15. The method of claim 1, further comprising receiving, by the service, a request to determine an arrangement for the number of plants for each of the one or more types of plants to optimize the layout of the garden based on one or more of the following: space of the garden, yield of the garden or market value of the garden.

16. The method of claim 1, wherein step (b) further comprises determining, via the service, the arrangement of the number of plants in the layout of the garden to provide one of an optimized yield or market value based on each of the one or more plant types.

17. The method of claim 1, wherein step (b) further comprises determining, via the service, an arrangement of the number of plants in the layout of the garden based on one or more of the following: the identified size, a shape and an orientation of the garden.

18. The method of claim 1, wherein step (b) further comprises limiting, by the service, an action of the user in arranging a plant of the each of the one or more types of plants based on compatibility between a first plant type and a second plant type.

19. The method of claim 1, wherein step (b) further comprises indicating, by the service, an action of the user in arranging a plant of the each of the one or more types of plants based on compatibility between a first plant type and a second plant type.
